(19) United States
(12) Patent Application Publication
(10) Pub. No.: US 2006/0168580 A1
(43) Pub. Date: Jul. 27, 2006

(54) Software-management system, recording medium, and information-processing device

(76) Inventors: Shunji Harada, Osaka-shi (JP); Toshihisa Nakano, Neyagawa-shi, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/541,413

(22) PCT Filed: Feb. 19, 2004
(86) PCT No.: PCT/JP04/01934

§ 371 Date: Jul. 5, 2005

(30) Foreign Application Priority Data
Feb. 21, 2003 (JP) 2003-045107

(51) Int. Cl. G06F 9/445

(52) U.S. Cl. 717/174

(57) ABSTRACT

A recording medium that is not easily tampered with and capable of avoiding invalid attacks on a communication channel between the recording medium and a terminal targeted for software installation, while being incapable of unauthorized updating of a correspondence relationship between software and license information. The recording medium includes a tamper-resistant module and an information-recording unit that has a normal storage area and a secure storage area. Software is recorded in the normal storage area, while a license count showing a permitted usage count of the software is recorded in the secure storage area in correspondence with signature data relating to the software. The tamper-resistant module performs mutual device authentication with the terminal, and if the license count in the secure storage area is within a predetermined value, outputs the software and the signature data to the terminal.

### TECHNICAL FIELD

The present invention relates to license management technology for computer software.

### BACKGROUND ART

Various technologies for managing computer program licenses have been proposed to date.

Japanese published patent application no. 10-27426, which aims of prevent the unlimited installation of application programs recorded on recording media and eliminate the unauthorized usage of such programs, discloses installation control technology for recording an installation count in a storage/playback area of a recording medium in accordance with installation execution, checking the recorded installation count when there is a request to install an application program on another recording medium, and executing the installation only when the installation count is less than a predetermined count.

Japanese published patent application no. 2002-268764 discloses a software license management system that prevents unauthorized software usage, based on information stored on an IC card. The management system, which is equipped with a software-recording medium, an IC card that stores license management information relating to software, and an information-processing terminal connected to a card reader/writer, is formed from a unit that reads license management information from the IC card via the card reader/writers of information-processing terminals held individually by software purchasers, and a unit that performs installation/uninstallation based on the license management information, and records information on the IC card identifying information-processing terminals with respect to which installation has been executed.

Furthermore, Japanese published patent application no. 2002-182769 discloses a software copy card realization method that aims to prevent the unauthorized use of software licenses. In the software copy card realization method, a removable recording medium is inserted in a cartridge containing a volatile storage area and a nonvolatile storage area, and the method uses an authentication algorithm stored in the nonvolatile storage area of the cartridge, a software installation program, system information unique to the system device that installs software, information unique to software recorded on a recording medium, and a cartridge-access device. The cartridge internally stores authentication data generated using the information unique to software recorded on the recording medium and information unique to terminals, and judges whether software installation on terminals is permitted based on the authentication data.

However, firstly, with the installation control technology disclosed by Japanese published patent application no. 10-27426, although the unlimited installation of application programs is prevented because of the permissibility of installation being judged using an installation count recorded on the recording medium, if a malicious third-party alters the installation count recorded in the record/playback area of the recording medium, the unlimited installation of application programs becomes possible (problem 1).

Also, according to this installation control technology, the installation count is conveyed from the recording medium to a terminal targeted for installation by passing over a communication channel between the recording medium and the terminal, and the terminal receives the installation count and judges whether installation is permitted using the installation count. Here, if a malicious third party alters the installation count over the communication channel, the unlimited installation of application programs becomes possible, as is the case above (problem 2).

Furthermore, because, with the above installation control technology, application programs are recorded on recording media in correspondence with installation counts, if a malicious third party conducts unauthorized alteration of the program/installation count correspondence on a recording medium by, for example, formally purchasing an inexpensive program and changing the program/installation count correspondence of the inexpensive program to the program/installation count correspondence of an expensive program that has not been formally purchased, it becomes possible to install the expensive program (problem 3).

Secondly, because, with the management system disclosed by Japanese published patent application no. 2002-26.8764, license management information relating to software is stored on an IC card, the license management information stored on the IC card cannot be easily altered, even by malicious third parties. Consequently, there is little chance of problems arising such as indicated in problem 1.

Also, according to this management system, the license management information is conveyed from the IC card to an information-processing terminal targeted for installation by passing over a communication channel between the IC card and the information-processing terminal, and the information-processing terminal receives the license management information and judges whether installation is permitted using the received information. Here, if a malicious third party alters the license management information over the communication channel, the unlimited installation of application programs becomes possible, as is the case with the installation control technology disclosed by Japanese published patent application no. 10-27426 above (problem 2).

Furthermore, because, with the above management system, IC cards are corresponded to information-processing terminals, if a malicious third party formally purchases a first software recording medium storing inexpensive software and a first IC card storing 100 devices worth of license management information, and formally purchases a second software recording medium storing expensive software and a second IC card storing 1 device worth of license management information, it becomes possible to install the expensive program by altering the second software recording medium so as to correspond to the first IC card (problem 3).

Thirdly, because, with the copy card realization method disclosed by Japanese published patent application no. 2002-182769, authentication data, which is used for judging whether software installation is permitted, is recorded on a cartridge, the authentication data recorded in the cartridge cannot easily be altered, even by malicious third parties. Consequently, there is little chance of problems arising such as indicated in problem 1.

Also, with this copy card realization method, if a malicious third party alters license-related information that passes over a communications channel between the cartridge access device and the cartridge, the unlimited installation of application programs becomes possible, as is the case with the installation control technology disclosed by Japanese published patent application no. 10-27426 above (problem 2).

Furthermore, with the above copy card realization method, if a malicious third party alters the correspondence between recording media and cartridges, it becomes possible to install expensive programs, as is the case with the management system disclosed by Japanese published patent application no. 2002-268764 above (problem 3)

### DISCLOSURE OF THE INVENTION

The present invention, which resolves the above issues (problems 1-3), aims to provide a software-management system, a recording medium, an information-processing device, a control method, a software-management method, and a computer program that make it difficult to tamper with recording media storing computer software, that enable invalid attacks on the correspondence relationship between recording media and terminals targeted for software installation to be avoided, and that prevent unauthorized updating of the correspondence relationship between software and license information from being performed.

To achieve the above object, the present invention is a recording medium having computer software recorded thereon. The recording medium includes a tamper-resistant module and an information storage unit that has a normal storage area and a secure storage area.

Computer software showing the execution procedures of computer commands is stored in the normal storage area, and a license count showing a permitted usage count of the computer software is recorded in the secure storage area in correspondence with signature data relating to the computer software.

The tamper-resistant module performs device authentication mutually with terminals targeted for installation of the computer software so as to confirm that targeted terminals are authorized devices.

When confirmed that a targeted terminal is an authorized device, the tamper-resistant module acquires encrypted terminal-specific information from the terminal. Terminal-specific information, being information unique to the terminal, is encrypted to generate the encrypted terminal-specific information. The tamper-resistant module decrypts the encrypted terminal-specific information to obtain terminal-specific information, and determines the processing to be reinstallation of the software if the obtained terminal-specific information is already recorded in the secure storage area. If not already recorded, the tamper-resistant module determines the processing to be a new installation, and writes the terminal-specific information to the secure storage area. The tamper-resistant module checks the license count recorded in the secure storage area, and outputs the computer software and the related signature data to the terminal if the license count is within a predetermined count.

The terminal receives the computer software and the signature data, verifies the signature data, and installs the computer software if verification is successful.

The tamper-resistant module, on the other hand, updates the license count, reducing the count by 1.

### BRIEF DESCRIPTION OF THE DRAWINGS

FIG. 1 shows a structure of a software-management system 10;

FIG. 2 is a block diagram showing structures of a software-writing device 100 and a memory card 200;

FIG. 3 is a block diagram showing structures of memory card 200 and an information-processing device 300;

FIG. 4 shows an exemplary data structure of a software management information table 231;

FIG. 5 is a flowchart showing operations performed in software-management system 10, particularly those relating to installation/uninstallation of software between memory card 200 and information-processing device 300 (cont. in FIG. 6);

FIG. 6 is a flowchart showing operations performed in software-management system 10, particularly those relating to installation/uninstallation of software between memory card 200 and information-processing device 300 (cont. in FIG. 7);

FIG. 7 is a flowchart showing operations performed in software-management system 10, particularly those relating to installation/uninstallation of software between memory card 200 and information-processing device 300 (cont. in FIG. 8);

FIG. 8 is a flowchart showing operations performed in software-management system 10, particularly those relating to installation/uninstallation of software between memory card 200 and information-processing device 300 (cont. from FIG. 7);

FIG. 9 is a flowchart showing in detail operations performed by a judgment unit 214;

FIG. 10 is a block diagram showing structures of a software-writing device 100b and a memory card 200b included in a software-management system 10b as a variation of the embodiment;

FIG. 11 shows an exemplary data structure of software management information;

FIG. 12 is a block diagram showing structures of memory card 200b and an information-processing device 300b included in software-management system 10b;

FIG. 13 is a block diagram showing structures of a memory card 200c and an information-processing device 300c included in a software-management system 10c as a further variation of the embodiment;

FIG. 14 is a block diagram showing structures of a memory card 200d and an information-processing device 300d included in a software-management system 10d as a further variation;

FIG. 15 shows exemplary data structures of a partial software management information table 219 and a software management information table 231;

FIG. 16 shows a structure of a software-management system 10e;

FIG. 17 is a block diagram showing structures of a memory card 200 and a software-writing device 100e included in software-management system 10e as a further variation;

FIG. 18 is a block diagram showing structures of a memory card 200 and an information-processing device 300e included in software-management system 10e as a further variation;

FIG. 19 is a flowchart showing the writing of software management information to memory card 200 by software-writing device 100e,

FIG. 20 is a flowchart showing the transmission of encrypted software by software-writing device 10e;

FIG. 21 shows a structure of a software-management system 10f;

FIG. 22 is a block diagram showing structures of a memory card 200f and a software-writing device 100f included in a software-management system 10f as a further variation;

FIG. 23 shows an example of information recorded in an information storage unit 113;

FIG. 24 shows an example of a software management table 121f;

FIG. 25 is a block diagram showing structures of memory card 200f and a content-distribution device 400f included in software-management system 10f as a further variation;

FIG. 26 shows an example of a software management table 231;

FIG. 27 is a block diagram showing structures of memory card 200f and an information-processing device 300f included in software-management system 10f as a further variation;

FIG. 28 shows an example of a software holding information table 331;

FIG. 29 shows an exemplary screen that includes a software list displayed by a display unit 322;

FIG. 30 is a flowchart showing operations when transmitting a software management table from software-writing device 100f to content-distribution device 400f;

FIG. 31 is a flowchart showing the writing of encrypted software to memory card 200f by software-writing device 100f;

FIG. 32 is a flowchart showing operations performed by a mobile telephone 500f when acquiring software management information that includes license information from content-distribution device 400f, and writing the acquired information to memory card 200f (cont. in FIG. 33);

FIG. 33 is a flowchart showing operations performed by mobile telephone 500f when acquiring software management information that includes license information from content-distribution device 400f, and writing the acquired information to memory card 200f (cont. from FIG. 32);

FIG. 34 is a flowchart showing operations to install, uninstall, duplicate, delete, and playback software performed by information-processing device 300f (cont. in FIG. 35);

FIG. 35 is a flowchart showing operations to install, uninstall, duplicate, delete, and playback software performed by information-processing device 300f (cont. in FIG. 36);

FIG. 36 is a flowchart showing operations to install, uninstall, duplicate, delete, and playback software performed by information-processing device 300f (cont. in FIG. 37);

FIG. 37 is a flowchart showing operations to install, uninstall, duplicate, delete, and playback software performed by information-processing device 300f (cont. in FIG. 38);

FIG. 38 is a flowchart showing operations to install, uninstall, duplicate, delete, and playback software performed by information-processing device 300f (cont. in FIG. 39);

FIG. 39 is a flowchart showing operations to install, uninstall, duplicate, delete, and playback software performed by information-processing device 300f (cont. in FIG. 40);

FIG. 40 is a flowchart showing operations to install, uninstall, duplicate, delete, and playback software performed by information-processing device 300f (cont. in FIG. 41);

FIG. 41 is a flowchart showing operations to install, uninstall, duplicate, delete, and playback software performed by information-processing device 300f (cont. in FIG. 42); and

FIG. 42 is a flowchart showing operations to install, uninstall, duplicate, delete, and playback software performed by information-processing device 300f (cont. from FIG. 41).

### BEST MODE FOR CARRYING OUT THE INVENTION

### 1. Embodiment 1

A software-management system 10 is described below as an embodiment pertaining to the present invention.

1.1 Structure of Software-Management System 10

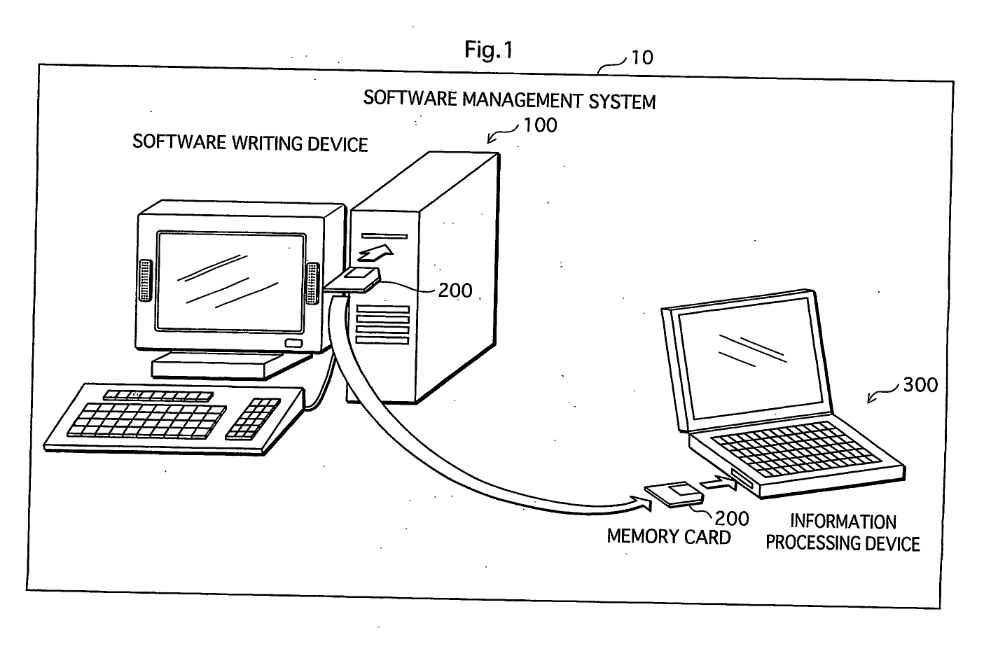

Software-management system 10 is, as shown in FIG. 1, constituted from a software-writing device 100, a portable memory card 200, and an information-processing device 300.

Software-writing device 100, which is a computer system constituted from a personal computer and the like, is used by a software provider in, for example, a software retail store, the customer service center of a consumer electronics (CE) manufacturer, or the like. Device 100 writes software to memory card 200, examples of such software including application programs executed by a computer, debugging programs for fixing problems with application programs, and software upgrade programs. The software is constituted from a plurality of computer commands, and shows the execution sequence of these computer commands. Memory card 200 is provided to a user with software written thereon, either for compensation or gratuitously.

Information-processing device 300 is a CE device used by a user such as a personal computer, a household electrical appliance, or the like. The user inserts memory card 200 into information-processing device 300, which reads software from memory card 200, stores (i.e. installs) the read software internally, and operates in accordance with the stored software. This enables the user to use software. communication channel, the unlimited installation of application programs becomes possible, as is the case above (problem 2).

Furthermore, because, with the above installation control technology, application programs are recorded on recording media in correspondence with installation counts, if a malicious third party conducts unauthorized alteration of the program/installation count correspondence on a recording medium by, for example, formally purchasing an inexpensive program and changing the program/installation count correspondence of the inexpensive program to the program/installation count correspondence of an expensive program that has not been formally purchased, it becomes possible to install the expensive program (problem 3).

Secondly, because, with the management system disclosed by Japanese published patent application no. 2002-268764, license management information relating to software is stored on an IC card, the license management information stored on the IC card cannot be easily altered, even by malicious third parties. Consequently, there is little chance of problems arising such as indicated in problem 1.

Also, according to this management system, the license management information is conveyed from the IC card to an conveyed as a key to encryption unit 112 over this line. The same applies to other connecting lines in this and other diagrams having keys drawn thereon.

(1) Information Storage Unit 113

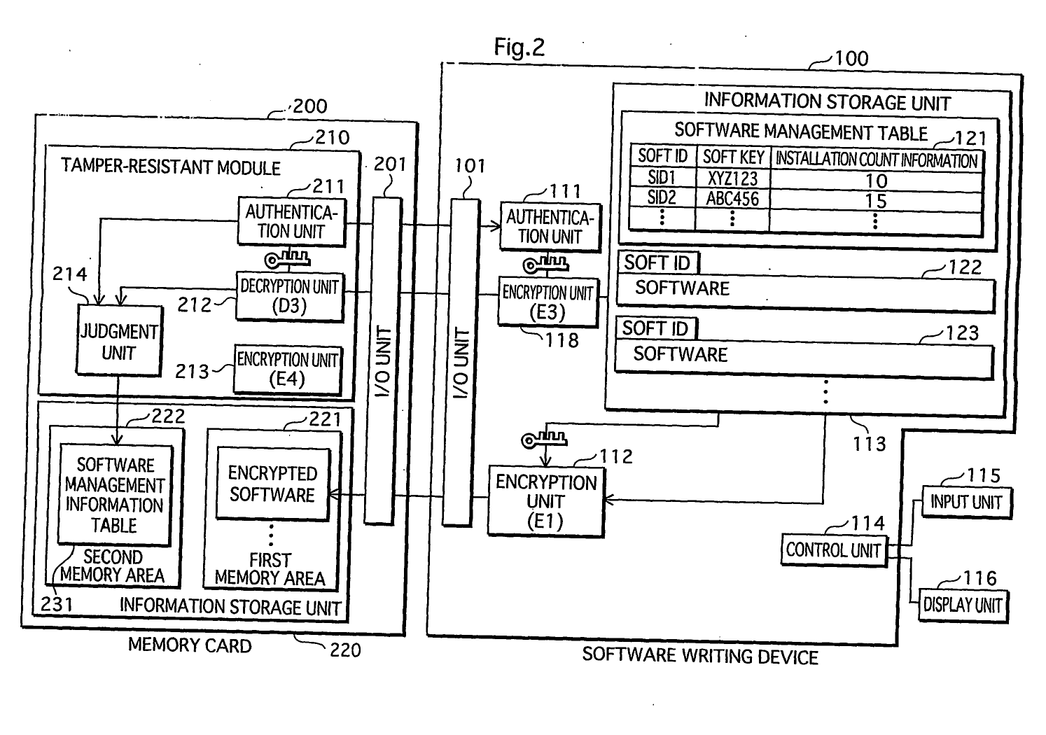

Information storage unit 113, as shown in FIG. 2, securely stores a software management (SM) table 121, and software 122, software 123, . . . .

SM table 121 is a data table that includes software management information (hereinafter “SM information”), each piece of which is constituted from a soft identifier (ID), a soft key, and installation count information.

A soft ID is a 64-bit identification number for identifying a corresponding piece of software.

A soft key is a 56-bit encryption key used in encrypting a corresponding piece of software.

Installation count information is a 16-bit piece of information showing the permitted number of times that a corresponding piece of software can be installed. For example, if the installation count information is “10”, a user is permitted a maximum of 10 installations of the software. Also, if “FFFF” (hexadecimal number) is designated as the installation count information, this shows that installation is unlimited. In this embodiment, the installation count information takes a fixed value, although it may be set to vary depending on the amount of software obtained by a user.

Software 122, software 123, . . . , are computer programs identified by soft IDs.

(2) Input Unit 115

Input unit 115 receives designations of software from the operator of software-writing device 100, acquires soft IDs identifying designated software from information storage unit 113, and outputs acquired soft IDs to control unit 114.

(3) Authentication Unit 111

When a user inserts memory card 200 into software-writing device 100, authentication unit 111 performs a challenge-response type of mutual device authentication with an authentication unit 211 in memory card 200.

Specifically, authentication unit 111 authenticates authentication unit 211, and is then authenticated by authentication unit 211.

When the authentication performed by both authentication units 111 and 211 is successful, unit 111 generates a 64-bit session key based on random number information used in the challenge-response authentication process performed between units 111 and 211, shares the generated session key secretly with unit 211, and then outputs the generated session key to encryption unit 118. It should be noted that a different session key is generated each time.

When authentication is successful, authentication unit 111 outputs authentication-successful information to control unit 114 showing that authentication was successful, and when not successful, unit 111 outputs authentication-failure information to control unit 114 showing that authentication was not successful.

Description of the challenge-response type of device authentication, being well known, is omitted here.

(4) Control Unit 114

Control unit 114 receives a soft ID from input unit 115, and receives authentication-successful information or authentication-failure information from authentication unit 111.

On receipt of authentication-successful information, control unit 114 outputs the received soft ID to encryption unit 118, and instructs unit 118 to encrypt SM information and write the encrypted SM information to memory card 200. Also, unit 114 outputs the received soft ID to encryption unit 112, and instructs unit 112 to encrypt software and write the encrypted software to memory card 200.

(5) Encryption Unit 118

Encryption unit 118 receives soft IDs and encryption instructions from control unit 114, and receives session keys from authentication unit 111.

On receipt of a soft ID and an encryption instruction, encryption unit 118 reads SM information that includes the received soft ID from SM table 121, and performs an encryption algorithm E3 on the read SM information using a session key received from authentication unit 111 to generate encrypted SM information. Unit 118 then outputs the encrypted information to memory card 200.

(6) Encryption Unit 112

Encryption unit 112 receives soft IDs and encryption instructions from control unit 114.

On receipt of a soft ID and an encryption instruction, encryption unit 112 reads SM information that includes the received soft ID from SM table 121, and extracts a soft key from the read information. Unit 112 then reads software identified by the received soft ID from information storage unit 113, and performs an encryption algorithm E1 on the read software using the extracted soft key as a key to generate encrypted software.

Here, encryption algorithm E1 is stipulated by the Data Encryption Standard (DES).

It should be noted that the encryption algorithm and the bit length of soft keys are not limited to that described above.

Next, encryption unit 112 outputs the encrypted software to memory card 200.

(7) Display Unit 116

Display unit 116 displays various kinds of information under the control of control unit 114.

(8) I/O Unit 101

I/O unit 101 performs the inputting and outputting of information between memory card 200 and authentication unit 111 and encryption units 118 and 112.

1.3 Structure of Memory Card 200

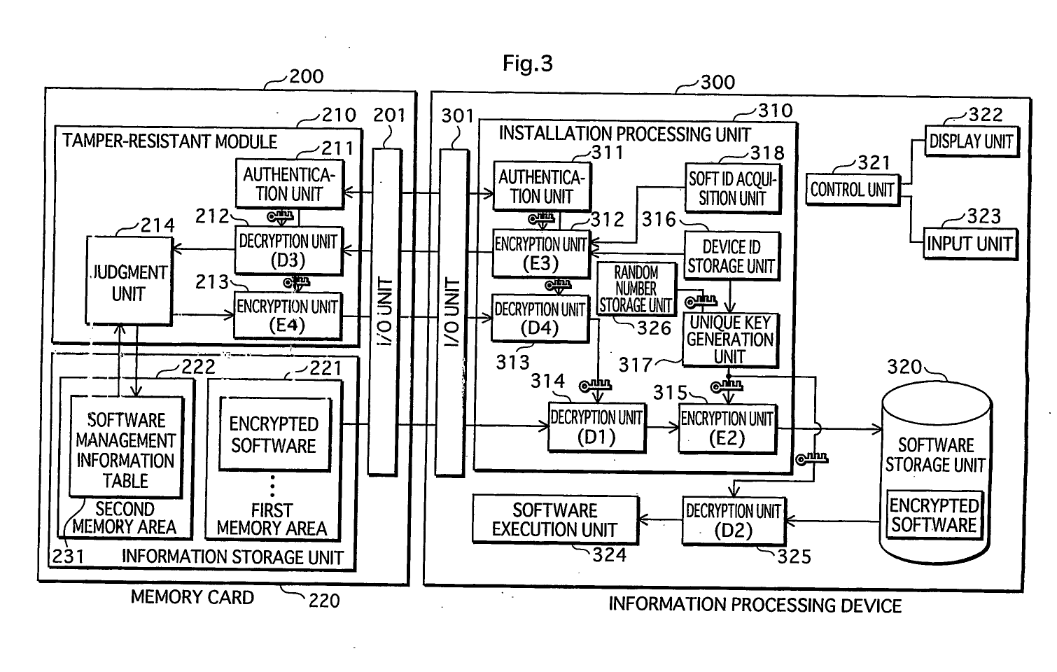

Memory card 200 is, as shown in FIGS. 2 and 3, constituted from an input/output (I/O) unit 201, a tamper-resistant module 210 and an information storage unit 220, the latter two of which cannot be read/written from outside (i.e. by an external entity) except via expressly permitted routes. Tamper-resistant module 210 is constituted from authentication unit 211, a decryption unit 212, an encryption unit 213, and a judgment unit 214. Information storage unit 220 is constituted from a first storage area 221 and a second storage area 222.

Here, tamper-resistant module 210 is, specifically, constituted from tamper-resistant hardware having tamper resistance, although unit 210 may be constituted from tamper-resistant software or from a combination of tamper-resistant hardware and software.

Information storage unit 220 is, specifically, constituted from mass storage flash memory.

(1) First Storage Area 221

First storage area 221 can be accessed from outside without express permission.

First storage area 221 has an area for storing one or more pieces of encrypted software.

(2) Second Storage Area 222

Second storage area 222 has a software management information (SMI) table 231.

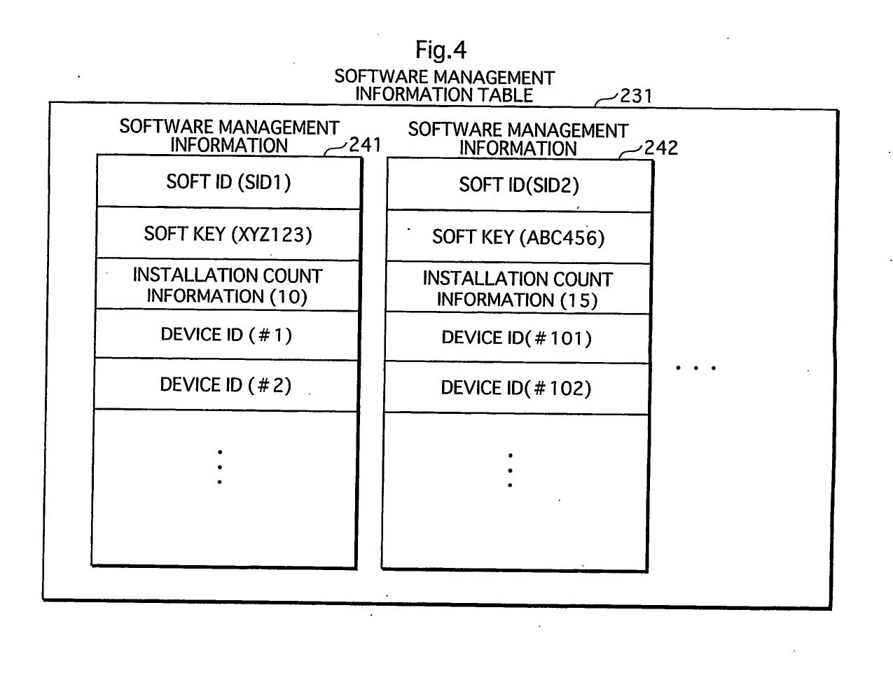

SMI table 231 includes, as shown in FIG. 4, an area for storing plural pieces of SM information 241, 242, . . . .

SM information 241 includes, as shown in FIG. 4, a soft ID, a soft key, installation count information, and a plurality of device IDs. Description of the soft ID, soft key, and installation count information, being the same as above, is omitted here.

Device IDs are identification numbers for uniquely identifying information-processing devices targeted for software installation.

The bracketed character strings “SID1”, “XYZ123”, “10”, “#1” and “#2” in SM information 241 shown in FIG. 4 are specific exemplary values for the soft ID, soft key, installation count information, and two device IDs.

It should be noted that while SM information 241 shown in FIG. 4 includes a plurality of device IDs, these device IDs are not yet included when information 241 is written from software-writing device 100 to memory card 200. Device IDs are written into information 241 when software is installed in information-processing devices. A user is able to install software in an arbitrary information processing device using a provided memory card when installing software for the first time.

Description of SM information 242, being the same as SM information 241, is omitted here.

(3) Authentication Unit 211

When memory card 200 is inserted into software-writing device 100, authentication unit 211 performs a challenge-response type of mutual device authentication with authentication unit 111 in device 100.

Specifically, authentication unit 211 is authenticated by authentication unit 111, and then authenticates authentication unit 111.

When the authentication performed by both authentication units 111 and 211 is successful, unit 211 generates a session key based on random number information used in the challenge-response authentication process with unit 111, outputs the generated session key to decryption unit 212, and outputs first authentication-successful information to judgment unit 214 showing that authentication was successful. On the other hand, if device authentication is not successful, unit 211 outputs first authentication-failure information to unit 214 showing that authentication was not successful. It should be noted that a different session key is generated each time.

When memory card 200 is inserted into information-processing device 300, authentication unit 211 performs a challenge-response type of mutual device authentication with an authentication unit 311 in device 300. Specifically, authentication unit 211 is authenticated by authentication unit 311, and then authenticates authentication unit 311.

When the authentication performed by both authentication units 211 and 311 is successful, unit 211 generates a session key based on random number information used in the challenge-response authentication process with unit 311, and shares the generated session key secretly with authentication unit 311. Unit 211 also outputs the generated session key to decryption unit 212 and encryption unit 213, and outputs second authentication-successful information to judgment unit 214 showing that authentication was successful. It should be noted that a different session key is generated each time.

When authentication fails, authentication unit 211 outputs second authentication-failure information to judgment unit 214 showing that authentication was not successful, and subsequent processing by memory card 200 is terminated. Consequently, in this case, software is not installed in information-processing device 300 from memory card 200. Memory card 200 notifies information-processing device 300 of the fact that install processing has been terminated, and device 300 notifies the user by display.

Description of the method of sharing session keys as part of the mutual device authentication process, being well known, is omitted here.

(4) Decryption Unit 212

Decryption unit 212 receives a session key from authentication unit 211.

Decryption unit 212 also receives encrypted SM information from software-writing device 100, performs a decryption algorithm D3 on the encrypted SM information using the received session key to generate SM information, and outputs the generated SM information to judgment unit 214.

Decryption unit 212 further receives an encrypted classification, an encrypted soft ID and an encrypted device ID from an encryption unit 312 included in information-processing device 300, performs decryption algorithm D3 on the encrypted classification, soft ID and device ID using the received session key to generate a classification, a soft ID and a device ID, and outputs the generated classification, soft ID and device ID to judgment unit 214.

Here, decryption algorithm D3 corresponds to encryption algorithm E3, and is for decrypting ciphertexts generated using encryption algorithm E3.

Also, when uninstalling software, decryption unit 212 receives encrypted completion information from encryption unit 312, performs decryption algorithm D3 on the encrypted completion information using the session key received from authentication unit 211 to generate completion information and random number R′, and outputs the generated completion information and random number R′ to judgment unit 214.

(5) Encryption Unit 213

Encryption unit 213 receives a session key from authentication unit 211, receives a soft key from judgment unit 214, and performs an encryption algorithm E4 on the received soft key using the received session key to generate an encrypted soft key.

Here, encryption algorithm E4 is stipulated by DES.

Encryption unit 213 outputs the encrypted soft key to information-processing device 300.

Also, when uninstalling software, encryption unit 213 receives a random number R and uninstallablity information from judgment unit 214, performs encryption algorithm E4 on the received random number R and uninstallablity information using the session key received from authentication unit 211 to generate encrypted uninstallablity information, and outputs the encrypted uninstallablity information to information-processing device 300.

(6) Judgment Unit 214

Judgment unit 214 receives first authentication-successful information or first authentication-failure information from authentication unit 211. Unit 214 also receives second authentication-successful information or second authentication-failure information from unit 211.

(A) On receipt of first authentication-successful information, judgment unit 214 further receives SM information from decryption unit 212, and adds the received SM information to SMI table 231.

(B) On receipt of second authentication-successful information, judgment unit 214 further receives a classification, a soft ID, and a device ID from decryption unit 212.

Judgment unit 214 judges whether the received classification shows install or uninstall.

(B1) Install

When judged that the received classification shows install, judgment unit 214 extracts SM information that includes the received soft ID from SMI table 231, and judges whether the received device ID is included in the extracted information.

(a1) When judged that the received device ID is not included, judgment unit 214 judges that the request is for software installation to a new information-processing device, and checks the installation count information included in the SM information.

(a1-1) If the installation count information is “1” or more, judgment unit 214 judges installation to be permitted, adds the device ID received from decryption unit 212 to the SM information, and overwrites a value obtained by subtracting “1” from the installation count information included in the SM information into the SM information in SMI table 231 to update the installation count information. Judgment unit 214 also outputs the soft key included in the SM information to encryption unit 213.

(a1-2) On the other hand, if the check reveals the installation count information to be “0”, judgment unit 214 judges installation to not be permitted, and terminates any subsequent processing consequently, in this case, software is not installed in information-processing device 300 from memory card 200. Memory card 200 notifies information-processing device 300 of the fact that install processing has been terminated, and device 300 notifies the user by display.

(a2) When judged that the received device ID is included, judgment unit 214 determines the request to be for the reinstallation on an information-processing device of software that is already installed therein.

(B2) When judged that the received classification shows uninstall, judgment unit 214 further extracts SM information that includes the received soft ID from SMI table 231, and judge whether the device ID received from decryption unit 212 is included in the extracted information.

If judged that the received device ID is not included, judgment unit 214 judges installation to not be possible, and generates 8-bit uninstallability information showing that uninstallation is not possible.

On the other hand, if judged that the received device ID is included, judgment unit 214 judges installation to be possible, and generates 8-bit uninstallability information showing that uninstallation is possible.

Next, judgment unit 214 generates a 56-bit random number R, and holds the generated random number R. Unit 214 then outputs to encryption unit 213, random number R and uninstallability information showing uninstallation to be either possible or not possible.

Also, judgment unit 214 receives completion information and random number R′, and judges whether the received random number R′ matches the held random number R. If not matched, uninstall processing is terminated. On the other hand, if matched, unit 214 further judges whether the completion information shows uninstallation to be complete, and terminates the subsequent uninstall processing if judged in the negative.

If judged that the completion information shows uninstallation to be complete, judgment unit 214 adds “1” to the installation count information included in the SM information, and overwrites the obtained value into the SM information in SMI table 231 to update the installation count information.

(C) On receipt of first or second authentication-failure information, judgment unit 214 terminates subsequent processing.

Although in embodiment 1, judgment unit 214 firstly checks whether a received device ID is included in SMI table 231 and then checks the installation count information, the present invention is not limited to this structure. Judgment unit 214 may check the installation count information before checking SMI table 231.

(7) I/O Unit 201

I/O unit 201 performs the inputting and outputting of information between an external device and authentication unit 211, decryption unit 212, encryption unit 213, and first storage area 221 in information storage unit 220.

1.4 Structure of Information-Processing Device 300

Information-processing device 300 is, as shown in FIG. 3, constituted from an installation-processing unit 310, a software storage unit 320, a control unit 321, a display unit 322, an input unit 323, a software execution unit 324, a decryption unit 325, and an input/output (I/O) unit 301. Installation-processing unit 310 is in turn constituted from authentication unit 311, encryption unit 312, decryption units 313 and 314, an encryption unit 315, a device ID storage unit 316, a unique key generation unit 317, a soft ID acquisition unit 318, and a random number storage unit 326.

Information-processing device 300 is, specifically, a computer system constituted from a microprocessor, a memory unit, an input unit, and a display unit. The memory unit includes a ROM, a RAM, a hard disk unit and the like, the input unit includes a keyboard, a mouse and the like, and the display unit includes a monitor and the like. A computer program for use in install processing is stored in the memory unit, and device 300 performs functions relating to install processing as a result of the microprocessor operating in compliance with the program stored in the memory unit. Also, device 300 performs functions provided by software installed from a memory card as a result of the microprocessor operating in compliance with the installed software.

(1) Software Storage Unit 320

Software storage unit 320 is, specifically, constituted from a hard disk unit, and has an area for storing one or more pieces of encrypted software installed from memory card 200.

(2) Device ID Storage Unit 316

Device ID storage unit 316 stores a device ID unique to information-processing device 300 so as to be unrewritable. The device ID is 64-bit identification information that uniquely identifies device 300.

(3) Soft ID Acquisition Unit 318

Soft ID acquisition unit 318 acquires the soft IDs of software designated for installation by a user.

An exemplary method for acquiring soft IDs is as follows. Display unit 322 in information-processing device 300 displays a list of encrypted software stored on memory card 200 with the memory card mounted on device 300 by the user. Input unit 323 receives designation of software that the user wants to install as the result of a mouse operation by the user. In this way, soft ID acquisition unit 318 acquires a soft ID corresponding to the designated software.

(4) Authentication Unit 311

When the user inserts memory card 200 into information-processing device 300, authentication unit 311 performs a challenge-response type of mutual device authentication with authentication unit 211 in memory card 200. Specifically, unit 311 authenticates unit 211, and is then authenticated by unit 211. The mutual authentication is only viewed as successful when the authentication performed by both units 311 and 211 is successful.

If the authentication performed by both units 311 and 211 is successful, unit 311 generates a session key based on random number information used in the challenge-response authentication process performed between units 311 and 211, and shares the generated session key secretly with unit 211. It should be noted that a different session key is generated each time.

Authentication unit 311 outputs the generated session key to encryption unit 312 and decryption unit 313.

If device authentication is not successful, authentication unit 311 terminates subsequent processing. Consequently, in this case, information-processing device 300 does not read software from memory card 200. Description of the challenge-response authentication and the method for sharing session keys, being well known, is omitted here.

(5) Encryption Unit 312

Encryption unit 312 receives a session key from authentication unit 311.

Encryption unit 312 then receives a classification from control unit 321 showing either software installation or uninstallation, receives a soft ID from soft ID acquisition unit 318, reads the device ID from device ID storage unit 316, and performs encryption algorithm E3 on the classification, soft ID and device ID using the session key received from authentication unit 311 to generate an encrypted classification, an encrypted soft ID and an encrypted device ID.

Here, encryption algorithm E3 is stipulated by DES.

Encryption unit 312 outputs the encrypted classification, soft ID and device ID to memory card 200.

Also, when uninstalling software, encryption unit 312 receives completion information and a random number R′, performs encryption algorithm E3 on the received completion information and random number R′ using the session key received from authentication unit 311 to generate encrypted completion information, and outputs the encrypted completion information to decryption unit 212.

(6) Decryption Unit 313

Decryption unit 313 receives a session key from authentication unit 311.

Decryption unit 313 then receives an encrypted soft key from memory card 200, and performs a decryption algorithm D4 on the encrypted soft key using the received session key to generate a soft key.

Here, decryption algorithm D4 is stipulated by DES and corresponds to encryption algorithm E4. Decryption algorithm D4 is for decrypting ciphertexts generated using encryption algorithm E4.

Decryption unit 313 outputs the generated soft key to decryption unit 314.

Also, when uninstalling software, decryption unit 313 receives encrypted uninstallability information from memory card 200, performs decryption algorithm D4 on the encrypted uninstallability information using the session key received from authentication unit 311 to generate uninstallability information and random number R′, and outputs the generated uninstallability information and random number R′ to control unit 321.

(7) Decryption Unit 314

Decryption unit 314 receives encrypted software corresponding to the soft ID from memory card 200, and receives a soft key from decryption unit 313.

Decryption unit 314 performs a decryption algorithm D1 on the encrypted software using the received soft key to generate software.

Here, decryption algorithm D1 is stipulated by DES and corresponds to encryption algorithm E1. Decryption algorithm D1 is for decrypting ciphertexts generated using encryption algorithm E1.

Decryption unit 314 outputs the generated software to encryption unit 315.

(8) Random Number Storage Unit 326

Random number storage unit 326 stores a 64-bit random number.

(9) Unique Key Generation Unit 317

Unique key generation unit 317 reads the device ID from device ID storage unit 316. Unit 317 then reads the 64-bit random number from random number storage unit 326, performs an encryption algorithm F on the read device ID using the read random number as a key to secretly generate a device unique key corresponding to the device ID, and outputs the generated device unique key to encryption unit 315 and decryption unit 325.

Here, encryption algorithm F is stipulated by DES. Moreover, the encryption algorithms and the bit-lengths of random numbers are not limited to those described above.

(10) Encryption Unit 315

Encryption unit 315 receives a device unique key from unique key generation unit 317, and receives software from decryption unit 314.

Encryption unit 315 performs an encryption algorithm E2 on the received software using the received device unique key to generate encrypted software.

Here, encryption algorithm E2 is stipulated by DES.

Encryption unit 315 writes the encrypted software to software storage unit 320.

(11) Decryption Unit 325

Decryption unit 325 receives a device unique key from unique key generation unit 317. Unit 325 also reads encrypted software from software storage unit 320 as the result of a user instruction. Unit 325 performs a decryption algorithm D2 on the encrypted software using the received device unique key to generate software.

Here, decryption algorithm D2 is stipulated by DES and corresponds to encryption algorithm E2. Decryption algorithm D2 is for decrypting ciphertexts generated using encryption algorithm E2.

Decryption unit 325 outputs the generated software to software execution unit 324.

(12) Software Execution Unit 324

Software execution unit 324 receives software from decryption unit 235 and operates in accordance with the received software.

(13) Control Unit 321

Control unit 321 controls the various components constituting information-processing device 300.

When uninstalling software, control unit 321 receives uninstallability information and random number R′ from decryption unit 313, and uses the received uninstallability information to judge whether uninstallation is possible.

If judged that uninstallation is not possible, control unit 321 does not perform uninstall processing, and generates 8-bit completion information showing that uninstallation is incomplete.

If judged that uninstallation is possible, control unit 321 uninstalls software by deactivating encrypted software stored in software storage unit 320 so as to render the encrypted software unexecutable.

Here, software is deactivated by, for example, updating the random number stored in random number storage unit 326 to a different random number.

Control unit 321 generates 8-bit completion information showing that software uninstallation is complete, and outputs the generated completion information and random number R′ to encryption unit 312.

(14) Input Unit 323

Input unit 323 receives inputs from the user. Specifically, when memory card 200 is mounted on information-processing device 300, input unit 323 receives a classification from the user showing software installation or uninstallation, and outputs the received classification to encryption unit 312 via control unit 321.

On receipt of a classification showing install, input unit 323 further receives designation from the user of software to install. On receipt of a classification showing uninstall, on the other hand, input unit 323 receives designation from the user of encrypted software to uninstall.

(15) Display Unit 322

Display unit 322 display various information under the control of control unit 321. Specifically, when input unit 323 receives a classification showing install, unit 322 displays a list of software stored on memory card 200. On the other hand, when input unit 323 receives a classification showing uninstall, unit 322 displays a list of encrypted software stored in software storage unit 320.

(16) I/O Unit 301

I/O unit 301 performs the inputting and outputting of information between memory card 200 and installation-processing unit 310.

1.5 Operations of Software-Management System 10

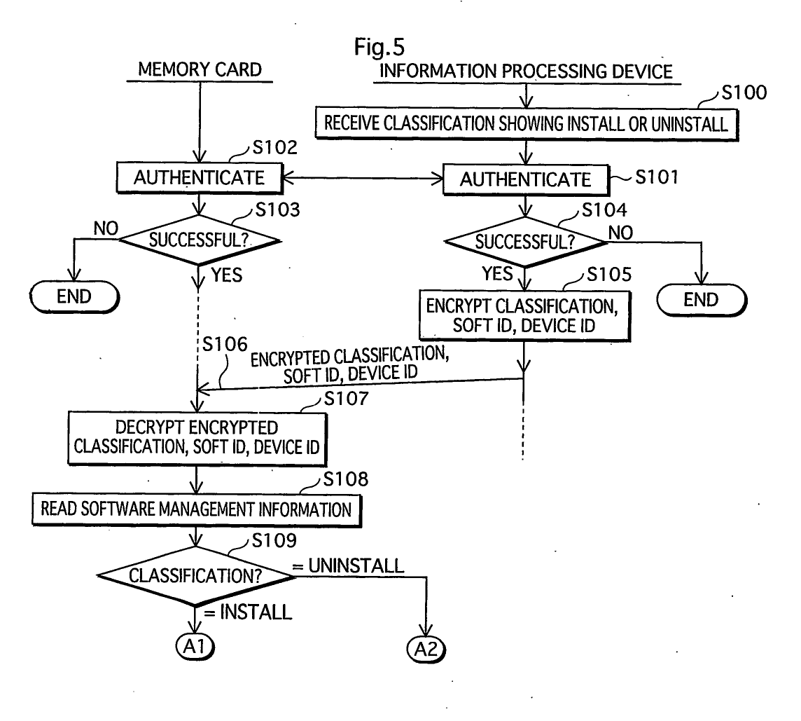

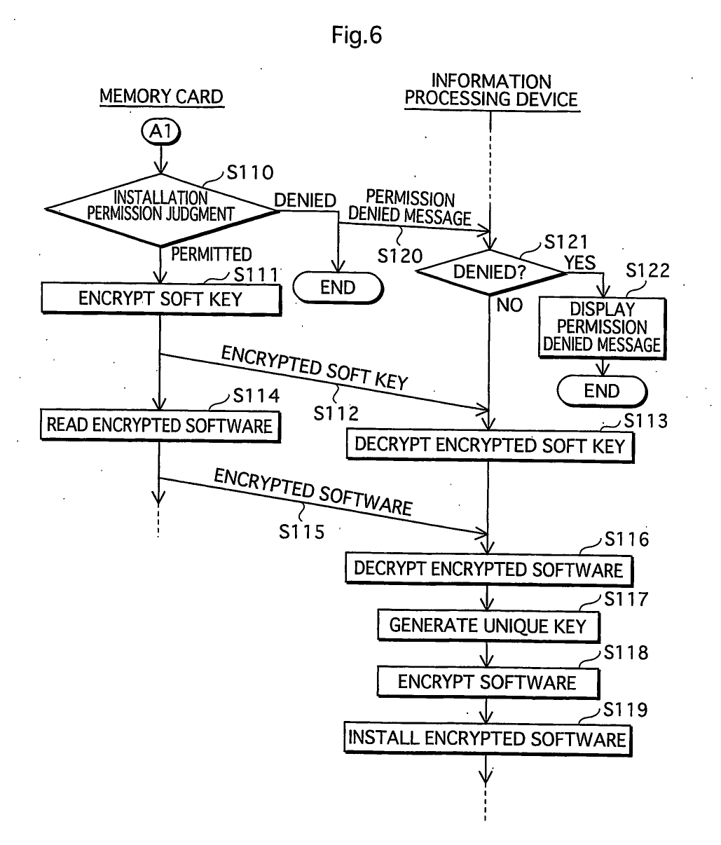

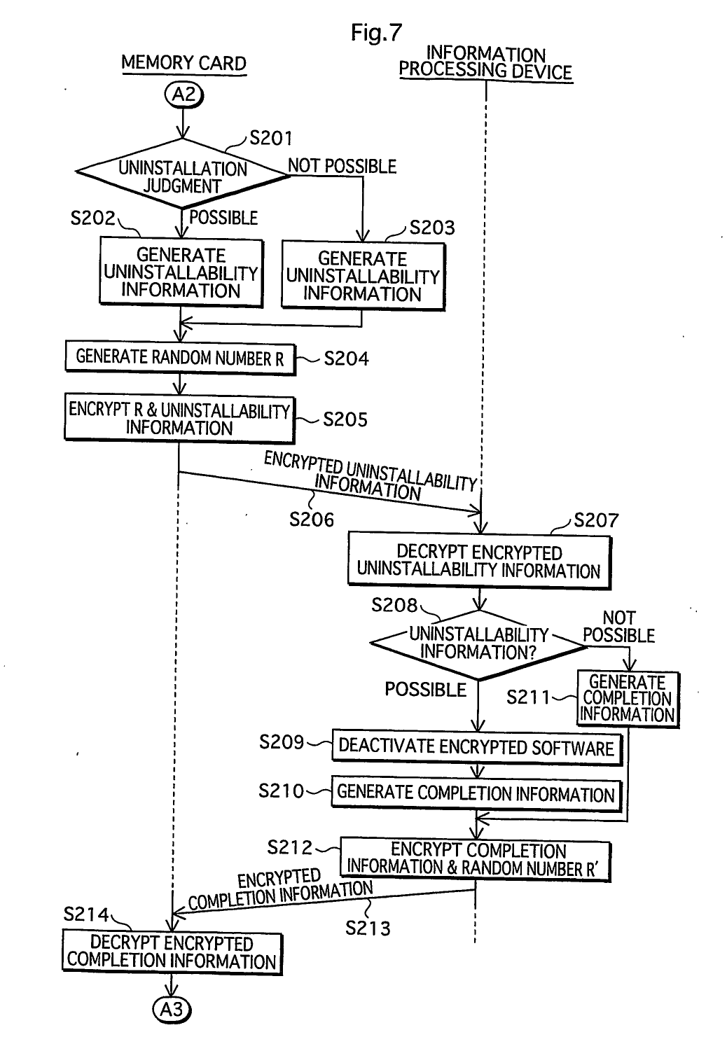

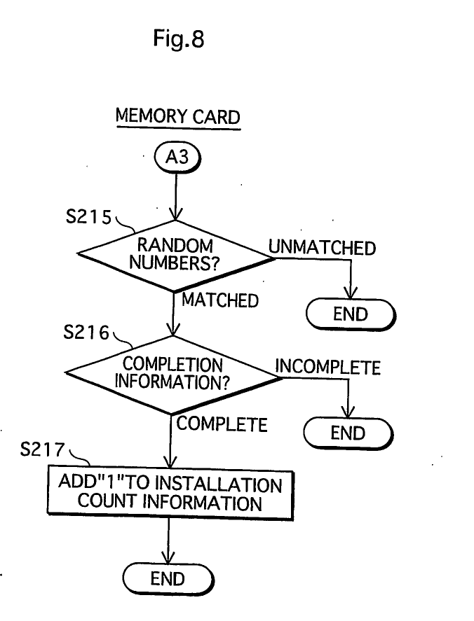

The operations of software-management system 10 in the case of software stored on memory card 200 mounted on information-processing device 300 being installed in device 300, and in the case of encrypted software already installed in device 300 being uninstalled are described below using the flowcharts shown in FIGS. 5 to 9.

When memory card 200 is mounted on information-processing device 300, input unit 323 receives a classification from the user showing software installation or uninstallation and outputs the received classification to encryption unit 312 via control unit 321. If the classification received by input unit 323 from the user shows install, display unit 322 displays a list of software stored on memory card 200 and input unit 323 receives designation from the user of software to install, and if the classification received by input unit 323 from the user shows uninstall, display unit 322 displays a list of encrypted software stored in software storage unit 320 and input unit 323 receives designation from the user of encrypted software to uninstall (step S100).

When information-processing device 300 receives designation of software or encrypted software, authentication unit 311 in device 300 and authentication unit 211 in memory card 200 perform mutual authentication (steps S101, S102).

When authentication is successful (step S104=YES), encryption unit 312 receives a session key from authentication unit 311 and a soft ID from soft ID acquisition unit 318, reads the device ID from device ID storage unit 316, encrypts the classification, soft ID and device ID using the received session key to generate an encrypted classification, soft ID and device ID (step S105), and transmits the encrypted classification, soft ID and device ID to memory card 200 (step S106).

When authentication is successful (step S103=YES), decryption unit 212 receives a session key from authentication unit 211, decrypts the encrypted classification, soft ID and device ID received from information-processing device 300 using the received session key, and sends the generated classification, soft ID and device ID to judgment unit 214 (step S107).

When authentication is not successful (steps S103/S104=NO), memory card 200 and information-processing device 300 terminate subsequent processing.

Judgment unit 214 reads SM information corresponding to the generated soft ID from second storage area 222 (step S108), and judges whether the generated classification shows software installation or uninstallation (step S109).

Install Processing: when judged that the classification shows software installation (step S109=INSTALL), judgment unit 214 judges whether installation is permitted based on the read SM information (step S110). The details of the step S110 judgment are described in a later section.

When judged that installation is not permitted (step S110=DENIED), judgment unit 214 transmits a message to information-processing device 300 showing that permission is denied (step S120), and memory card 200 terminates processing.

On receipt of a permission-denied message from memory card 200 (step S121), control unit 321 controls display unit 322 to display the permission-denied message, and display unit 322 displays the permission-denied message (step S122), after which information-processing device 300 terminates processing.

When judged that installation is permitted (step S110=PERMITTED), judgment unit 214 sends the soft key included in the SM information to encryption unit 213, which encrypts the soft key using a session key received from authentication unit 211 to generate an encrypted soft key (step S111), and transmits the encrypted soft key to information-processing device 300 (step S112). If a permission-denied message is not received (step S121=NO), decryption unit 313 decrypts the encrypted soft key received from memory card 200 using a session key received from authentication unit 311 (step S113).

Furthermore, encrypted software is read from first storage area 221 (step S114), and transmitted to information-processing device 300 (step S115). Decryption unit 314 decrypts the encrypted software using the soft key received from decryption unit 313 (step S116), and sends the decrypted software to encryption unit 315, unique key generation unit 317 reads the device ID from device ID storage unit 316 and generates a device unique key using the read device ID (step S117), and encryption unit 315 encrypts software received from decryption unit 314 using the device unique key received from unique key generation unit 317 to generate software (step S118), and installs the encrypted software by writing the encrypted software to software storage unit 320 (step S119).

Thus completes the installation of encrypted software.

Uninstall Processing: When judges that the classification received from decryption unit 212 shows software uninstallation, judgment unit 214 further judges whether the device ID received from decryption unit 212 is included in the SM information read from second storage area 222. If judged to not be included, unit 214 judges software uninstallation to not be possible (step S201=NOT POSSIBLE), and generates 8-bit uninstallability information showing uninstallation to not be possible (step S203). On the other hand, if judged to be included, unit 214 judges software uninstallation to be possible (step S201=POSSIBLE), and generates 8-bit uninstallability information showing uninstallation to be possible (step S202).

Next, judgment unit 214 generates a 56-bit random number R and holds the generated random number R (step S204), Unit 214 then outputs random number R and uninstallability information showing uninstallation to be either possible or not possible to encryption unit 213, which receives random number R and the uninstallability information, performs encryption algorithm E4 on the received random number R and uninstallability information using the session key received from authentication unit 211 to generate encrypted uninstallability information (step S205), and outputs the encrypted information to information-processing device 300 (step S206).

Decryption unit 313 receives the encrypted uninstallability information from memory card 200 (step S206), performs decryption algorithm D4 of on the encrypted information using the session key received from authentication unit 311 to generate uninstallability information and random number R′, and outputs the generated information and random number R′ to control unit 321 (step

Control unit 321 receives the uninstallability information and random number R′, and judges whether the uninstallation is possible using the received information (step S208). If judged to not be possible (step S208=NOT POSSIBLE), unit 321 generates 8-bit completion information showing uninstallation to be incomplete, without performing uninstall processing (step S211), and transfers to step S212.

If judged that uninstallation is possible (step S208=POSSIBLE), control unit 321 uninstalls software by deactivating encrypted software stored in software storage unit 320 so as to make the encrypted software unexecutable. Here, software may be deactivated, for example, by updating the random number stored in random number storage unit 326 to a different random number (step S209). Unit 321 then generates 8-bit completion information showing software uninstallation to be complete (step S210).

Control unit 321 outputs the completion information and random number R′ to encryption unit 312, which receives the completion information and random number R′, performs encryption algorithm E3 on the received information and random number R′ using the session key received from authentication unit 311 to generate encrypted completion information (step S212), and outputs the encrypted information to decryption Unlit 212 (step S213).

Decryption unit 212 receives the encrypted completion information from encryption unit 312 (step S213), performs decryption algorithm D3 on the encrypted information using the session key received from authentication unit 211 to generate completion information and random number R′, and outputs the generated information and random number R′ to judgment unit 214 (step S214).

Judgment unit 214 receives the completion information and random number R′, judges whether the received random number R′ matches the held random number R (step S215), and if not matched (step S215=UNMATCHED), terminates the uninstall processing.

If matched (step S215=MATCHED), judgment unit 214 further judges whether the completion information shows uninstallation to be complete (step S216), and if judged in the negative (step S216=INCOMPLETE), unit 214 terminates subsequent processing.

On the other hand, if the completion information shows uninstallation to be complete (step S216=COMPLETE), judgment unit 214 adds “1” to the installation count information included in the SM information, and overwrites the obtained value into the SM information in SMI table 231 to update the installation count information (step S217).

Thus completes the uninstall processing.

Using the procedures for uninstalling software described above, it is possible when a user wants to exchange a hard disk unit on which encrypted software is installed for a new hard disk unit, to newly install software on the other hard disk unit by executing the uninstall processing, even when the installation count information recorded on a memory card shows “0”, for example.

In the case of plural pieces of encrypted software being installed in software storage unit 320, decryption unit 325 may, prior to the random number stored in random number storage unit 326 being updated at step S209, decrypt all of the encrypted software, except for that targeted for uninstallation, using a device unique key generated with the pre-update random number, to generate software. Encryption unit 315 may re-encrypt the generated software using a device unique key generated with the post-update random number, to generate re-encrypted software, which is then stored in software storage unit 320 (step S209a).

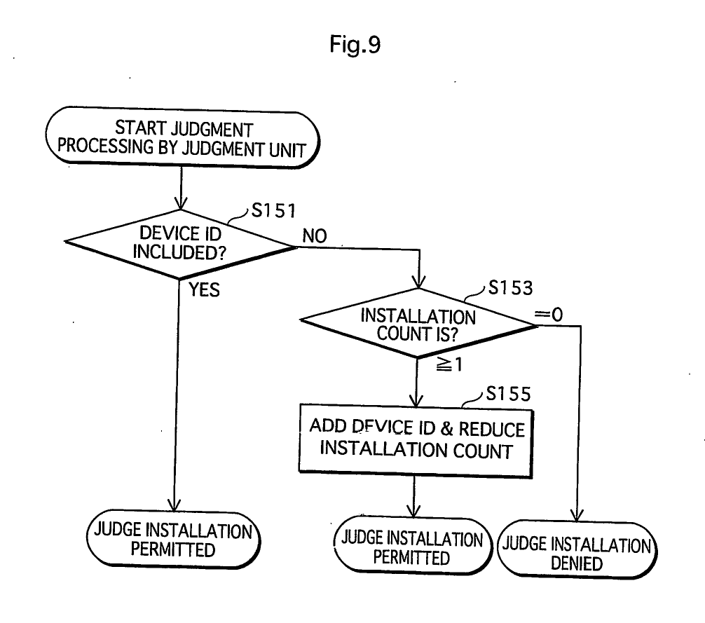

Step 110 Operations in Detail: The operations performed by judgment unit 214 at step 110 are described below in detail using the flowchart shown in FIG. 9.

Judgment unit 214 checks whether the device ID received from decryption unit 214 is included in the SM information received from second storage area 222 (step S151). If not included (step S151=NO), unit 214 determines the request to be for installation to a new information-processing device, checks the installation count included in the SM information (step S153), and if greater than or equal to “1” (step S153=≧1), judges installation to be permitted. As this time, unit 214, in addition to writing the device ID received from decryption unit 212 to the SM information read from second storage area 222, writes updated SM information (i.e. installation count reduced by “1”) to second storage area 222 (step S155). If the installation count is “0” (step S153=0), unit 214 judges installation to not be permitted. Also, if at step S151 the device ID is judged to be included in the SM information (step S151=YES), unit 214 determines the request to be for reinstallation on an information-processing device in which the software has already been installed, and that installation is permitted.

Furthermore, the SM information may be structured to include installation period information. Here, the installation period information, which has a 64-bit length and limits the time period during which software corresponding to the SM information can be installed, is constituted from a start date-time and an end date-time showing respectively the start/end date and time of the period during which installation is permitted. The user is only permitted to install the software in the period from the start date-time to the end date-time. In this period, the user can install the software an unlimited number of times. Here, in the case of both installation period information and installation count information being specified, software cannot be installed once either the permitted time period has ended or the software has been installed a maximum number of times.

1.6 Other Examples

Software-management system 10 may be structured as described below.

(1) Although software-writing device 100 is described in embodiment 1 as being a computer system constituted from a personal computer and the like, the present invention is not limited to this structure. For example, device 100 may be constituted from a kiosk terminal.

Furthermore, input unit 115 and display unit 116 may be constituted from a touch-panel display unit.

(2) Although memory card 200 having software written thereon is described in embodiment 1 as being provided to a user, the present invention is not limited to this structure.

This memory card 200 may be provided to a staff member in, for example, a software retail store or the customer service center of a CE manufacturer, and the staff member may insert memory card 200 into the information-processing device of a user.

(3) Although SM information 241 is described in embodiment 1 as not including a device ID at the time that software-writing device 100 writes SM information to memory card 200, the present invention is not limited to this structure.

SM information 241 may include a device ID at the time that software-writing device 100 writes SM information to memory card 20.

This structure allows the software provider to restrict the information-processing devices onto which a user can install software when software is first installed using a memory card provided by the user.

(4) Although decryption unit 314 is described in embodiment 1 as decrypting encrypted software received from memory card 200 using a soft key (step S116), and encryption unit 315 is described as encrypting the decrypted software using a device unique key (steps S117-S118) and storing the encrypted software in software storage unit 320, the present invention is not limited to these structures.

Unique key generation unit 317 may generate a device unique key (step S117), and encryption unit 315 may encrypt a soft key received from decryption unit 313 using the device unique key to generate an encrypted soft key (step S118′), and install software by writing the generated soft key and encrypted software received from memory card 200 to software storage unit 320 (step S119′).

In this case, information-processing device 300 further includes a decryption unit 327 (not depicted), and when software is executed, decryption unit 325 decrypts the encrypted soft key using the received device unique key to generate a soft key, and outputs the generated soft key to decryption unit 327, which receives the soft key, decrypts the encrypted software using the received soft key to generate software, and outputs the generated software to software execution unit 324. Unit 324 receives the generated software from decryption unit 327 and operates in accordance with the received software.

(5) Although unique key generation unit 317 is described in embodiment 1 as reading a 64-bit random number from random number storage unit 326 when software is to be installed or executed, and updating the random number in unit 326 when software is to be uninstalled, the present invention is not limited to this structure.

Random number storage unit 326 may store 64-bit random numbers in correspondence with pieces of software for installation. Then when a piece of software is to be installed or executed, unique key generation unit 317 may read the 64-bit random number corresponding to the piece of software from unit 326, and when the software is to be uninstalled, unit 317 may update the random number corresponding to the software in unit 326.

With this structure, the decryption and re-encryption of software required in embodiment 1 when plural pieces of encrypted software are installed in software storage unit 320 at step S209 (step S209a) is not necessary.

(6) Although in embodiment 1 a challenge-response type of authentication is applied as the authentication method, and the generation of session keys based on random number information used in the challenge-response authentication is applied as the method for sharing session keys, the present invention is not limited to these structures.

For example, a method using digital signatures may be applied as the authentication method, and a Diffie-Hellman (DH) key agreement method may be applied as the method for sharing session keys.

Authentication using digital signatures and DH key agreement are described in detail in Modern Cryptography by Shinichi Ikeno and Kenji Koyama (The Institute of Electronics, Information and Communication Engineers), on p. 83 and p. 175, respectively.

(7) Although in embodiment 1 a soft key is already included in SM information at the time that a software-writing device writes software to a memory card, the SM information being read from SM table 121 by encryption unit 112 and the soft key extracted from the read information, the present invention is not limited to this structure.

For example, the soft key need not be included in the SM information. In this case, encryption unit 112 generates a soft key, in addition to reading SM information from SM table 121 that includes the soft ID received from control unit 114.

Furthermore, although in embodiment 1 information storage unit 113 of software-writing device 100 stores software, and encryption unit 112 encrypts the stored software and writes the encrypted software to memory card 200, the present invention is not limited to these structures.

For example, information storage unit 113 may store software that is encrypted in advance using a soft key, and software-writing device 100 may read encrypted software from information storage unit 113 and write the read encrypted software as is to memory card 200.

(8) Although the uninstallability information and completion information have 8-bit lengths and the random number R has a 56-bit length in the uninstall processing of embodiment 1, the present invention is not limited to these bit lengths.

(9) Although encryption algorithm E3 is performed on completion information and random number R′ using a session key at step S212 of the uninstall processing in embodiment 1, the present invention is not limited to this structure.

For example, encryption algorithm E3 may be performed on completion information and a bitwise complement (R″) of random number R′ using a session key. In this case, judgment unit 214 judges at step S215 whether the received random number R″matches the bitwise complement of the held random number R.

(10) Although software is described in embodiment 1 as being a computer program or the like, software may be data associated with the operations of a computer program.

(11) A model ID (or group ID) may be includable in the SM table of embodiment 1. Here, a model ID (or a group ID) is identification information identifying the type of particular information-processing devices. Information-processing devices are considered to be of the same type if, for example, they include microprocessors with the same processing performance or hard disks/memories of the same capacity, or if made by the same manufacturer.

In this case, each information-processing device has a model ID (or group ID), and a memory card installs and uninstalls software with respect to devices of the same model (or group), based on the model IDs (or group IDs). This structure allows software installation to be restricted to information-processing devices of a particular model.

(12) Version information relating to software may be includable in the SM table of embodiment 1.

In this case, an information-processing device receives the version information as well as the soft ID of software for installation, and a memory card judges whether software can be installed/uninstalled and installs/uninstalls a particular version of software based on both the version information and the soft ID.

(13) Although encrypted software is described in embodiment 1 as being stored in a first storage area of the memory card, the present invention is not limited to this structure.

An information-processing device may acquire encrypted software separately via a communications circuit, another recording medium, or the like.

(14) Although memory cared 200 is described in embodiment 1 as being inserted into software-writing device 100, memory card 200 may be of a contactless type. In this case, software-writing device 100 is provided with a read/write unit capable of read/write accesses to a contactless memory card 200 without any physical contact. With the above structures, users are no longer required to insert memory card 200 into software-writing device 100. Instead, it is sufficient to hold memory card 200 in proximity of software-writing device 100, so that the memory card 100 and software-writing device 100 perform the above-described processing.

2. Variation 1

A software-management system 10b (not depicted) is Described below as a variation of embodiment 1.

Software-management system 10b is constituted from a software-writing device 10b, a portable memory card 200b, and an information-processing device 300b, which have similar structures to software-writing device 100, memory card 200, and information-processing device 300, respectively.

Software-writing device 10b, memory card 200b and information-processing device 300b are described below focusing on the respective differences with software-writing device 100, memory card 200 and information-processing device 300.

2.1 Structure of Software-Writing Device 100b

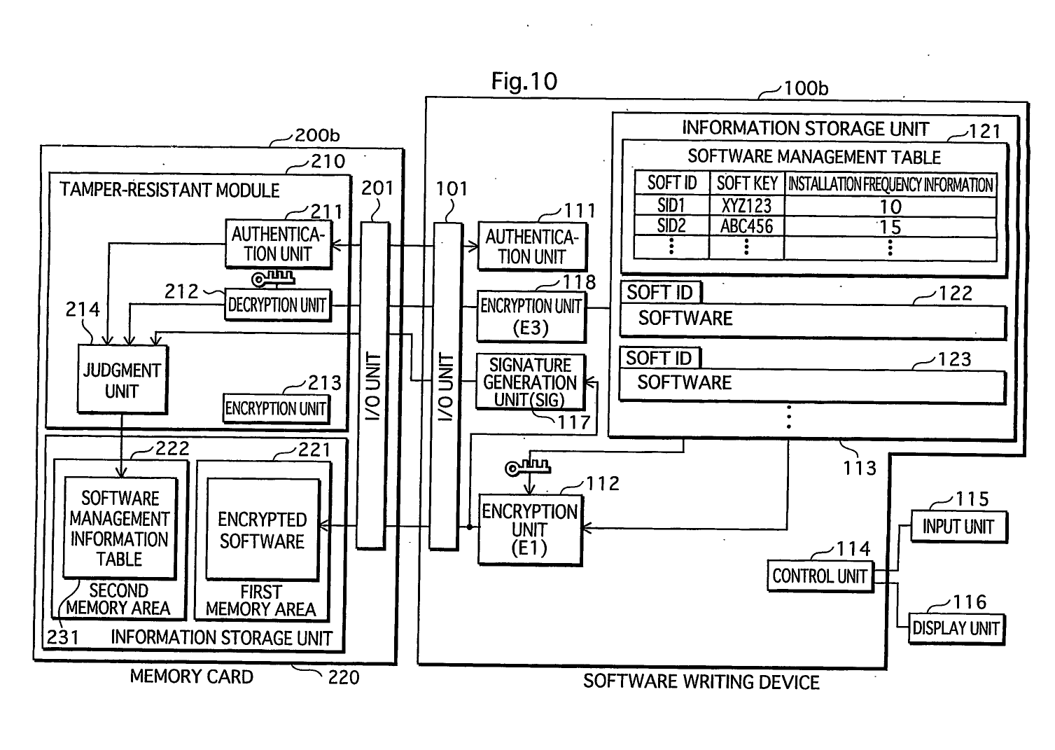

Software-writing device 100b is, as shown in FIG. 10, constituted from authentication unit 111, encryption unit 112, information storage unit 113, control unit 114, a signature generation unit 117, encryption unit 118, and I/O unit 101. Input unit 115 and display unit 116 are connected to device 10b.

Software-writing device 100b thus has a similar structure to software-writing device 100, and differs by virtue of including signature generation unit 117.

(1) Signature Generation Unit 117

Signature generation unit 117 receives encrypted software from encryption unit 112. On receipt of encrypted software, unit 117 performs a digital signature generation algorithm SIG on the encrypted software to generate soft signature data.

Here, digital signature generation algorithm SIG is based on a method for generating a 160-bit digital signature using elliptic curve cryptography. Also, the soft signature data has a 320-bit length. Elliptic curve cryptography is described in detail in Cryptography: Theory and Practice by Douglas R. Stinson (CRC Press, Inc.).

Signature generation unit 117 outputs the generated soft signature data to judgment unit 214 of memory card 200b via I/O unit 101.

2.2 Structure of Memory Card 200b

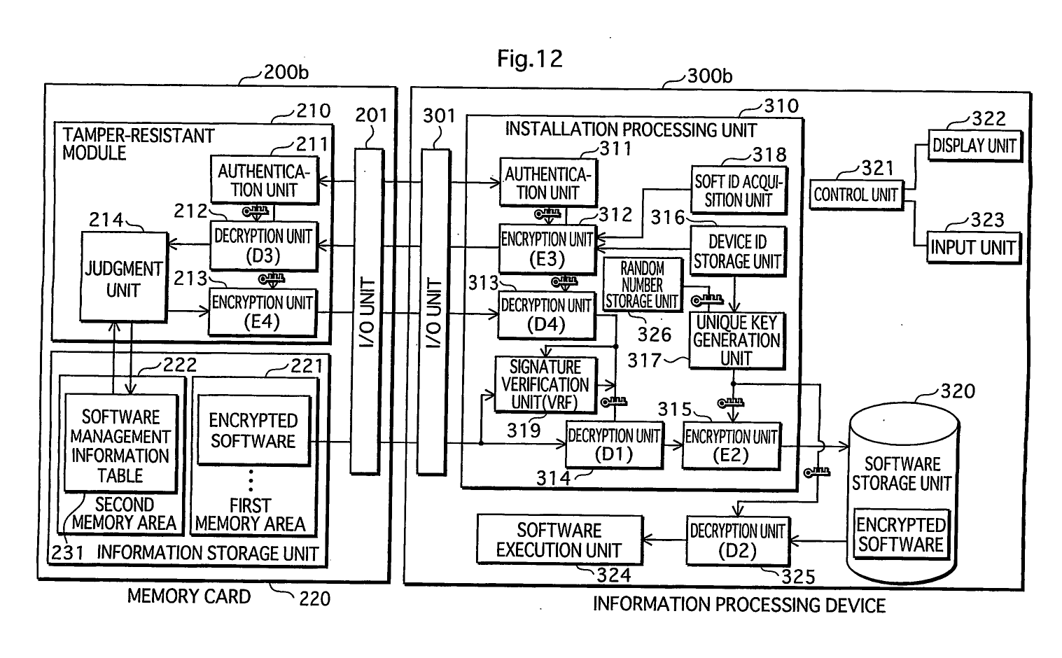

Memory card 200b is, as shown in FIGS. 10 and 12, constituted from a tamper-resistant module 210, an information storage unit 220, and an I/O unit 201, which have similar structures to tamper-resistant module 210, information storage unit 220, and I/O unit 201 in memory card 200, respectively.

The following description focuses on the differences with memory card 200.

(1) Judgment Unit 214

On receipt of first authentication-successful information from authentication unit 211, judgment unit 214 further receives soft signature data. Unit 214 writes the received soft signature data into SM information received from decryption unit 212, and adds the SM information that includes the soft signature data to SMI table 231.

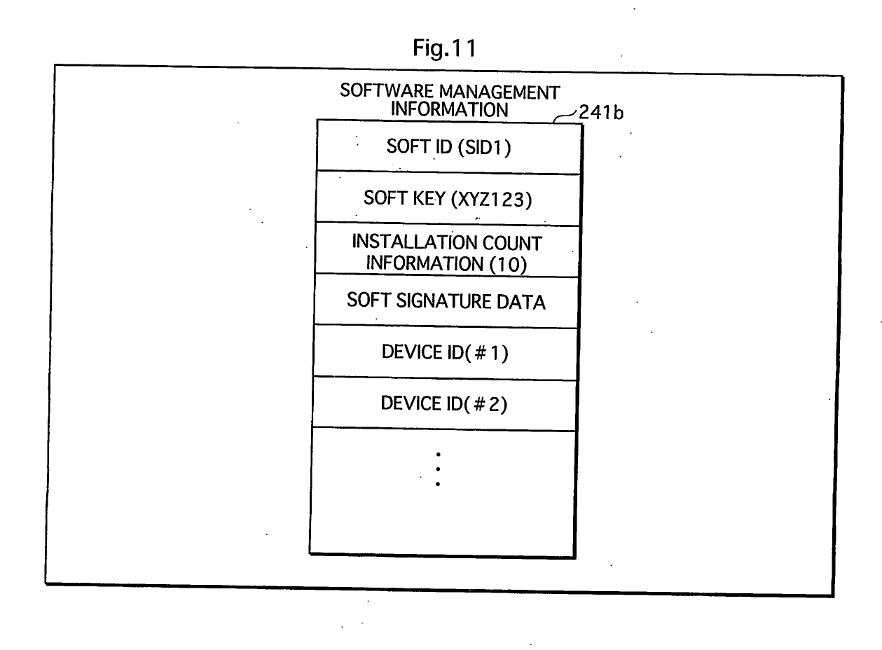

An example of SM information that has soft signature data written therein is shown in FIG. 11. SM information 241b shown in FIG. 11 includes a soft ID, a soft key, installation count information, soft signature data, and a plurality of device IDs.

It should be noted that while SM information 241b shown in FIG. 11 includes a plurality of device IDs, these device IDs are not yet included when information 241b is written from software-writing device 100b to memory card 200b.

Judgment unit 214, having received second authentication-successful information and judged installation to be permissible, outputs the received soft signature data to information-processing device 300b.

2.3 Structure of Information-Processing Device 300b

Information-processing device 300b is, as shown in FIG. 12, constituted from an installation-processing unit 310, a software storage unit 320, a control unit 321, a display unit 322, an input unit 323, a software execution unit 324, a decryption unit 325, and an I/O unit 301. Installation-processing unit 310 is in turn constituted from authentication unit 311, encryption unit 312, decryption units 313 and 314, encryption unit 315, device ID storage unit 316, unique key generation unit 317, soft ID acquisition unit 318, and a signature verification unit 319.

Information-processing device 300b thus has a similar structure to information-processing device 300, and differs by virtue of including signature verification unit 319.

(1) Signature Verification Unit 319

Signature verification unit 319 receives soft signature data includes in SM information from judgment unit 214 in memory card 200b, and reads encrypted software from first storage area 221 in memory card 200b.

Signature verification unit 319 performs a digital signature verification algorithm VRF on the received soft signature data and encrypted software to generate information showing verification to have either succeeded or failed.

Here, digital signature verification algorithm VRF is based on a method for verifying a digital signature using an elliptic curve.

Signature verification unit 319 outputs the generated verification-successful or verification-failure information to decryption unit 314.

(2) Decryption Unit 314

Decryption unit 314 receives verification-successful or verification-failure information from signature verification unit 319.

On receipt of verification-failure information, decryption unit 314 terminates subsequent processing.

On receipt of verification-successful information, decryption unit 314 moves on to decrypt encrypted software.

2.4 Other Examples

(1) Although signature generation unit 117 is described in variation 1 as performing digital signature generation algorithm SIG on encrypted software to generate soft signature data, the present invention is not limited to this structure.

Signature generation unit 117 may perform digital signature generation algorithm SIG on encrypted software, a soft key and installation count information to generate soft signature data.

In this case, encryption unit 213, at the time of software installation, encrypts a soft key and installation count information using a session key to generate encrypted information, and transmits the encrypted information to information-processing device 300b. Decryption unit 313 in device 300b decrypts the encrypted information using a session key to generate a soft key and installation count information, and signature verification unit 319 performs digital signature verification algorithm VRF on the generated soft key and installation count information in addition to soft signature data and encrypted software, to verify the soft signature data.

Alternatively, signature generation unit 117 may perform digital signature generation algorithm SIG on software to generate soft signature data.

In this case, signature verification unit 319, at the time of software installation, performs digital signature verification algorithm VRF on soft signature data and software to verify the soft signature data. It should be noted that in this, case software is not encrypted before being written into first storage area 221 in memory card 200b.

3. Variation 2

A software-management system 10c (not depicted) is described below as a variation of software-management system 10b.

Software-management system 10c is constituted from a software-writing device 100c (not depicted), a portable memory card 200c, and an information-processing device 300c. Software-writing device 100c has the same structure as software-writing device 10b. Memory card 200c and information-processing device 300c have similar structures IO memory card 200b and information-processing device 300b, respectively.

Memory card 200c and information-processing device 300c are described below focusing on the differences with memory card 200b and information-processing device 300b.

3.1 Structure of Memory Card 200c

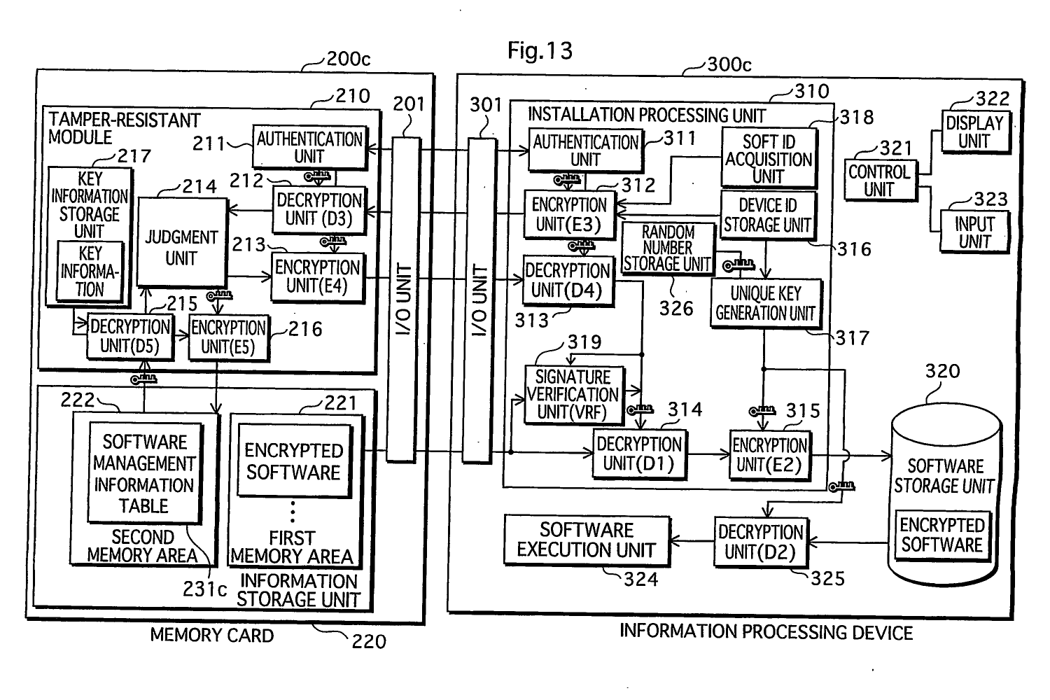

Memory card 200c is, as shown in FIG. 13, constituted from a tamper-resistant module 210 an information storage unit 220, and an I/O unit 201, which have respectively similar structures to tamper-resistant module 210, information storage unit 220, and I/O unit 201 in memory card 200b.

The following description focuses on the differences with memory card 200b.

Tamper-resistant module 210 is constituted from authentication unit 211, decryption unit 212, encryption unit 213, judgment unit 214, a decryption unit 215, an encryption unit 216, and a key information storage unit 217. As such, unit 210 in memory card 200c differs from unit 210 in memory card 200b by virtue of including decryption unit 215, encryption unit 216, and key information storage unit 217.

(1) Judgment Unit 214

On receipt of first authentication-successful information from authentication unit 211, judgment unit 214 further receives soft signature data. Unit 214 writes the received soft signature data into SM information received from decryption unit 212, and outputs the SM information that includes the soft signature data to encryption unit 216.

An example of SM information that has soft signature data written therein is shown in FIG. 11.

Judgment unit 214 also receives SM information from decryption unit 215.

(2) Key Information Storage Unit 217

Key information storage unit 217 stores key information. Key information is 56-bit information used in encrypting or decrypting SM information.

(3) Encryption Unit 216

Encryption unit 216 receives SM information from judgment unit 214, and reads key information from key information storage unit 217.

Encryption unit 216 performs an encryption algorithm E5 on the received SM information using the read key information to generate encrypted SM information, and writes the encrypted information to an encrypted SM information table 231c in second storage area 222.

Here, encryption algorithm E5 is stipulated by DES.

(4) Decryption Unit 215

Decryption unit 215 reads encrypted SM information from encrypted SM information table 231c in second storage area 222, and reads key information from key information storage unit 217.

Decryption unit 215 performs a decryption algorithm D5 on the encrypted SM information using the read key information to generate SM information, and outputs the generated SM information to judgment unit 214.

Here, decryption algorithm D5 is stipulated by DES and corresponds to encryption algorithm E5.

3.2 Structure of Information-Processing Device 300c

Information-processing device 300c is, as shown in FIG. 13, constituted from an installation-processing unit 310, a software storage unit 320, a control unit 321, a display unit 322, an input unit 323, a software execution unit 324, a decryption unit 325, and an I/O unit 301. Installation-processing unit 310 is in turn constituted from authentication unit 311, encryption unit 312, decryption units 313 and 314, encryption unit 315, device ID storage unit 316, unique key generation unit 317, soft ID acquisition unit 318, and a signature verification unit 319.

A detailed description of information-processing device 300c, being of similar structure to information-processing device 300b, is omitted here.

3.3 Other Examples

Although key information stored in key information storage unit 217 has a fixed value in variation 2, the present invention is not limited to this structure. The key information may have a variable value.

In this case, decryption unit 215, at the time of SM information being outputted from second storage area 222 to judgment unit 214, may read all of the encrypted SM information from SMI table 231c, read key information from key information storage unit 217, and perform decryption algorithm D5 on the encrypted SM information using the read key information to generate SM information. Next, at the time of SM information being outputted from judgment unit 214 to second storage area 222, judgment unit 214 may update the key information and store the updated key information in key information storage unit 217, and encryption unit 216 may perform an encryption algorithm E5 on all of the SM information using the updated key information to generate encrypted SM information, and write the encrypted SM information to encrypted SMI table 231c in second storage area 222.

Furthermore, although variation 2 describes encryption unit 216 in memory card 200c as writing encrypted SM information generated by encrypting SM information using key information stored in key information storage unit 217 to second storage area 222, and decryption unit 215 as decrypting the encrypted SM information stored in second storage area 222 using the key information, and outputting the generated SM information to judgment unit 214, the present invention is not limited to this structure.

For example, the following structures are possible.

Memory card 200c secretly transfers key information stored in key information storage unit 217 to a device (software writing device or content-distribution device) for accessing memory card 200c.

The accessing device, in an internal encryption unit, encrypts SM information using the received key information, and transfers the encrypted SM information to memory card 200c.

Memory card 200c writes the encrypted SM information to second storage area 222. Decryption unit 215 decrypts the encrypted SM information stored in second storage area 222 using the key information to generate SM information, and outputs the generated SM information to judgment unit 214.

Also, the key information may be key information unique to memory card 200c.

Alternatively, the key information may be a public key/secret key pair unique to memory card 200c. In this case, memory card 200c transfers the public key to the accessing device. The accessing device receives the public key, encrypts SM information stored internally using this public key to generate encrypted SM information, and transfers the encrypted SM information to memory card 200c. Memory card 200c writes the encrypted SM information to second storage area 222. Decryption unit 215 in memory card 200c decrypts the encrypted SM information using the secret key to generate SM information, and outputs the generated SM information to judgment unit 214.

4. Variation 3

A software-management system 10d (not depicted) is described below as a variation of software-management system 10b shown in variation 1.

Software-management system 10d is constituted from a software-writing device 100d (not depicted), a portable memory card 200d, and an information-processing device 300d. Software-writing device 100d, memory card 200d and information-processing device 300d have similar structures to software-writing device 100b, memory card 200b and information-processing device 300b, respectively.

Memory card 200d is described below focusing on the differences with memory card 200b.

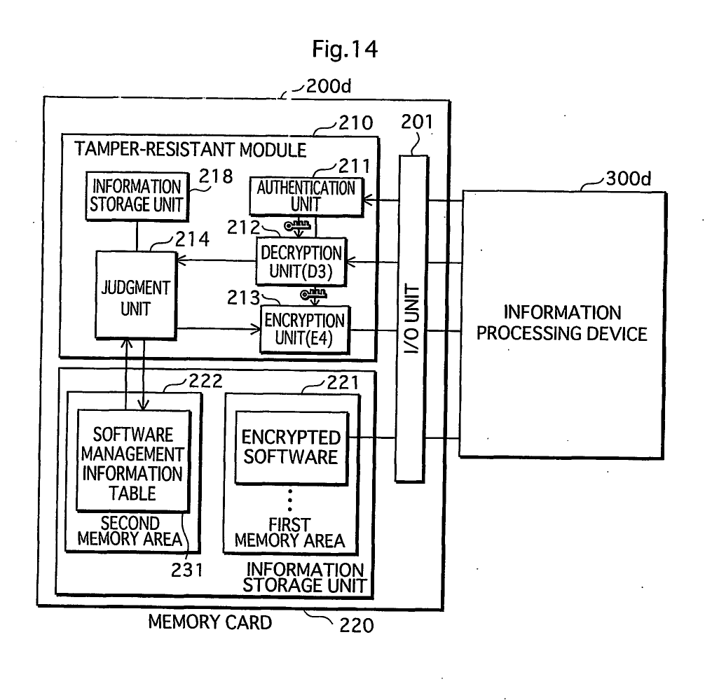

Memory card 200d is, as shown in FIG. 14, constituted from a tamper-resistant module 210, an information storage unit 220, and an I/O unit 201. Tamper-resistant module 210 is in turn constituted from authentication unit 211, decryption unit 212, encryption unit 213, judgment unit 214, and information storage unit 218. As such, unit 210 in memory card 200c differs from unit 210 in memory card 200b by virtue of including information storage unit 218.

(1) Information Storage Unit 218

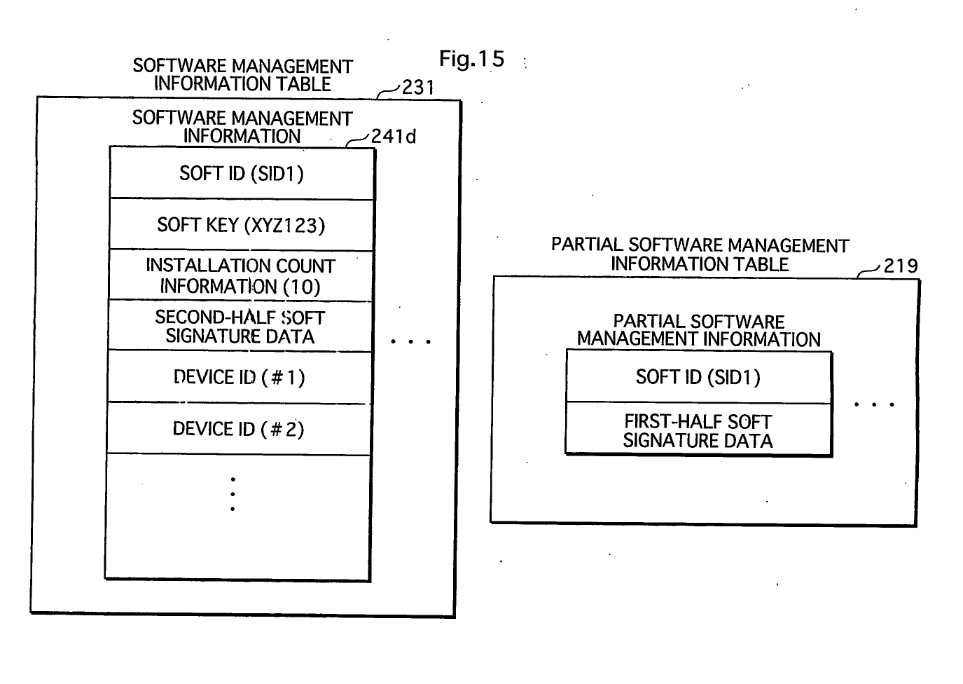

Information storage unit 218 has a partial SM information (SMI) table 219, an example of which is shown in FIG. 15.

Partial SMI table 219 includes an area for storing plural pieces of partial SM information. Each piece of partial SM information is constituted from a soft ID and first-half soft signature data.

Description of soft IDs, being the same as above, is omitted here.

First-half soft signature data is constituted from the first half of a bit string structuring soft signature data, which is the same as described above. Specifically, first-half soft signature data is constituted from a bit string having a 160-bit length.

(2) SMI Table 231

SMI table 231 includes, as shown in FIG. 15, an area for storing SM information 241d, . . . , as one example.

SM information 241d includes a soft ID, a soft key, installation count information, second-half soft signature data, and a plurality of device IDs.

Description of soft IDs, soft keys, installation count information and device IDs, being the same as above, is omitted here.

Second-half soft signature data is constituted from the second half of a bit string structuring soft signature data as described above. Specifically, second-half soft signature data is constituted from a bit string having a 160-bit length.

(3) Judgment Unit 214

On receipt of first authentication-successful information from authentication unit 211, judgment unit 214 further receives soft signature data. Unit 214 divides the received soft signature data into two bit strings to generate first-half and second-half soft signature data. The first bit string generated as a result of dividing the soft signature data is the first-half soft signature data, and the second bit string generated is the second-half soft signature data. The first-half and second-half soft signature data each have a 160-bit length.

Judgment unit 214 generates partial SM information constituted from the generated first-half soft signature data and a received soft ID, and writes the generated partial SM information into partial SMI table 219 in information storage unit 218. Also unit 214 adds SM information that includes the generated second-half soft signature data to SMI table 231.

Judgment unit 214 also reads partial SM information that includes the soft ID from partial SMI table 219, and reads SM information that includes the soft ID from SMI table 231. Unit 214 extracts first-half soft signature data from the read partial SM information, extracts second-half soft signature data from the read SM information, and concatenates the extracted first-half aid second-half soft signature data to generate soft signature data.

As described above, tamper-resistant module 210 additionally includes information storage unit 218, which stores a part of the SMI table.

Specifically, information storage unit 218 stores, as one example, at least part of a piece of soft signature data. The SMI table in second storage area 222 stores the remaining part of the soft signature data. Judgment unit 214 reconstitutes the piece of soft signature data from the partial soft signature data stored in unit 218 and the remaining part of the soft signature data included in the SM information read from second storage area 222.

It should be noted that although information storage unit 218 is described as storing the first half of a piece of soft signature data, the present invention is not limited to this structure.

5. Variation 4

The following description relates to a software-management system 10e as a variation of software-management system 10 shown in FIG. 1.

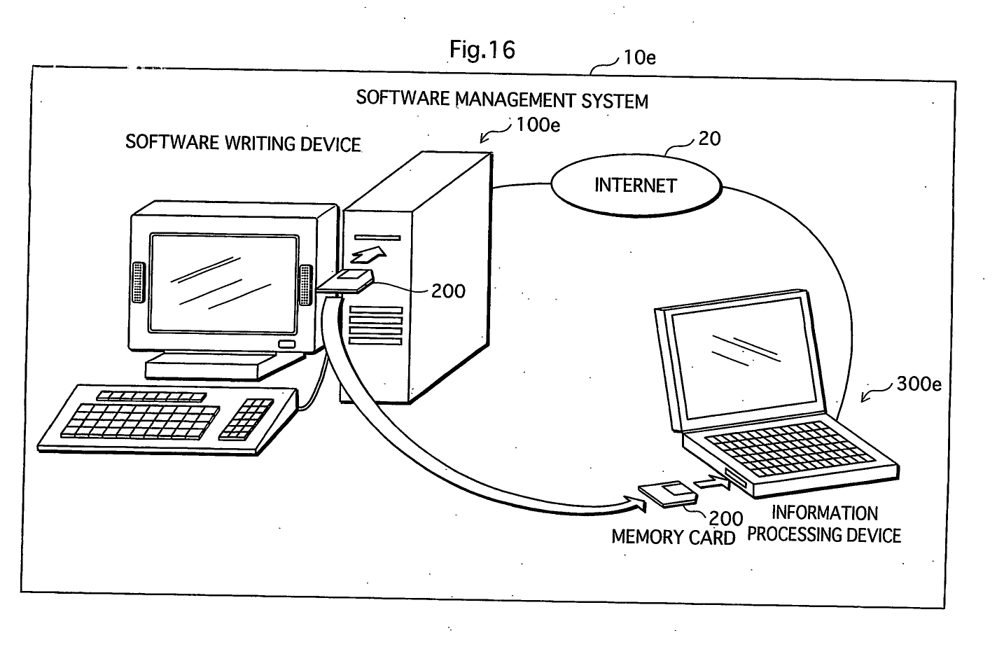

Software-management system 10e is, as shown in FIG. 16, constituted from a software-writing device 100e, a portable memory card 200 and an information-processing device 300e, devices 100e and 300e being connected to Internet 20.

Memory card 200 included in software-management system 10e has the same structure as memory card 200 included in software-management system 10.

Software-writing device 100e and information-processing device 300e have similar structures to writing device 100 and information-processing device 300 included in software-management system 10.

In software-management system 10e, encrypted software is transmitted to memory card 200 from software-writing device 100e via Internet 20 and information-processing device 300e, and written to memory card 200.

SM information is written directly to memory card 200 by software-writing device 100e, the same as software-management system 10.

Software-writing device 10e and information-processing device 300e are described below, focusing on the differences with devices 100 and 300.

(1) Software-Writing Device 100e

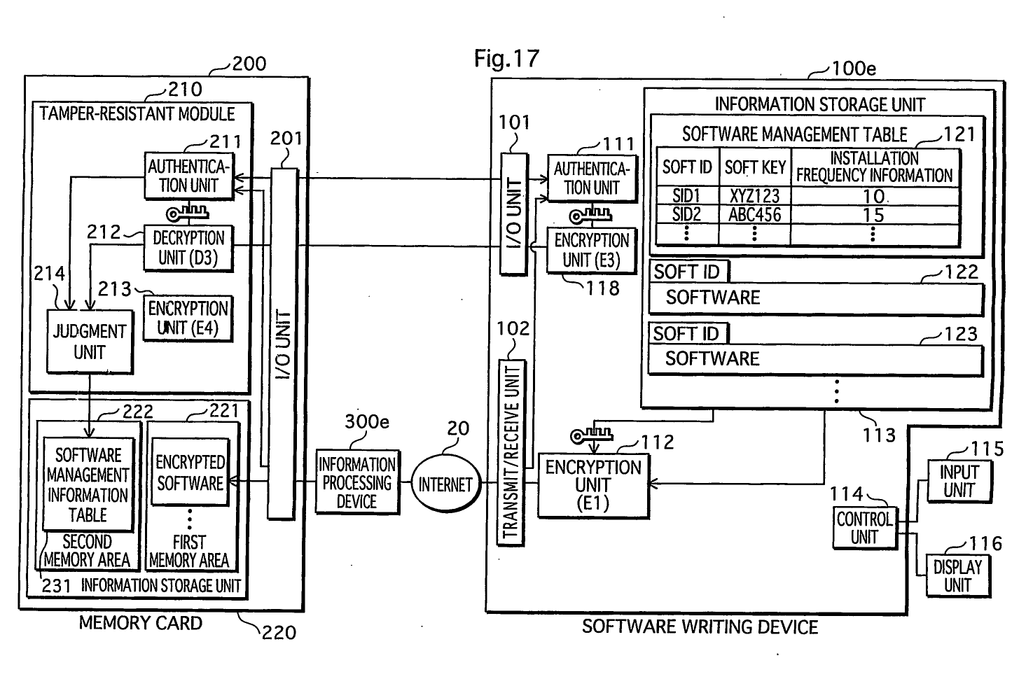

Software-writing device 100e is, as shown in FIG. 17, constituted from an authentication unit 111, an encryption unit 112, an information storage unit 113, a control unit 114, an encryption unit 118, a transmit/receive unit 102, and an input/output (I/O) unit 101. An input unit 115 and a display unit 116 are connected to device 10e.

These elements are similar to the elements comprising software-writing device 100. The following description focuses on the differences with the elements of device 100.

Transmit/Receive Unit 102

Transmit/receive unit 102 is connected to Internet 20, and transmits/receives information with an external device connected via Internet 20 and units 112 and 111. Here, the external device is information-processing device 300e.

Encryption Unit 112

Encryption unit 112 outputs encrypted software to memory card 200 via transmit/receive unit 102, Internet 20, and information-processing device 300e.

Authentication Unit 111

Authentication unit 111, when memory card 200 is mounted on software-writing device 100e, performs mutual device authentication with authentication unit 211 via I/O unit 101 and I/O unit 201 of memory card 200.

Also, authentication unit 111, when software-writing device 100e and information-processing device 300e having memory card 200 mounted thereon are connected by Internet 20, performs mutual device authentication with authentication unit 211 via transmit/receive unit 102, Internet 20, information-processing device 300e, and I/O unit 201 of memory card 200.

(2) Information-Processing Device 300e

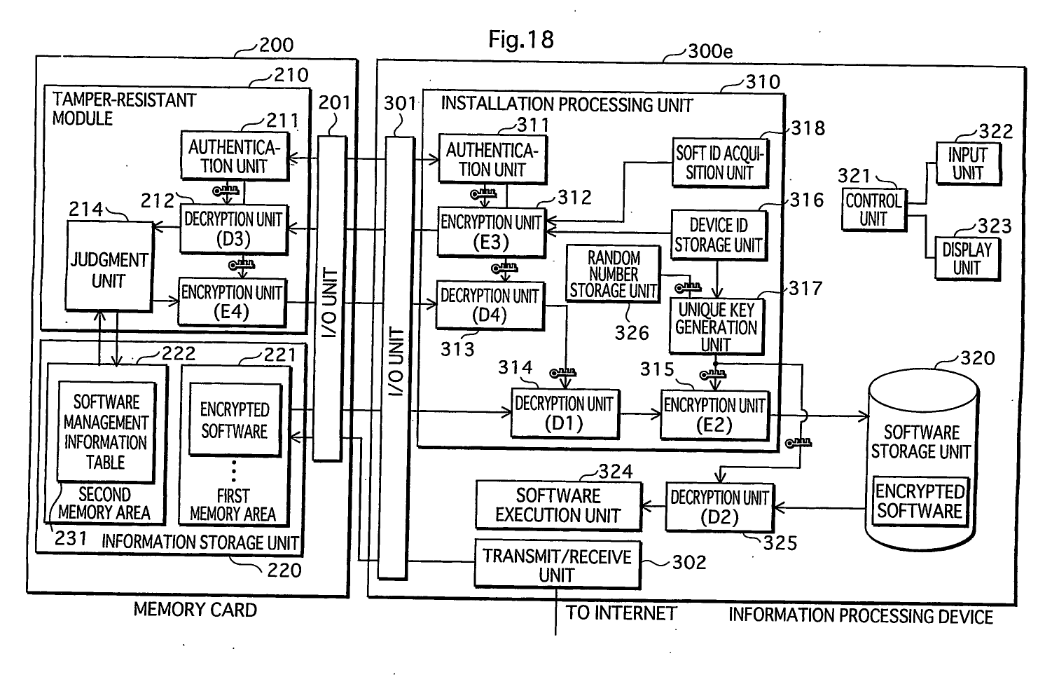

Information-processing device 300e is, as shown in FIG. 18, constituted from an installation-processing unit 310, a software storage unit 320, a control unit 321, a display unit 322, an input unit 323, a software execution unit 324, a decryption unit 325, an input/output (I/O) unit 301, and a transmit/receive unit 302.

These elements are similar to the elements constituting information-processing device 300. The following description focuses on the differences with the elements of device 300.

Transmit/Receive Unit 302

Transmit/receive unit 302 is connected to Internet 20, and transmits/receives information with an external device connected via Internet 20 and I/O unit 301. Here, the external device is software-writing device 100e.

Specifically, transmit/receive unit 302 receives encrypted software from software-writing device 100e via Internet 20, and outputs the encrypted software to I/O unit 301.

I/O Unit 301

I/O unit 301 receives encrypted software from transmit/receive unit 302, and writes the encrypted software to first memory area 221 of information storage unit 220 in memory card 200.

(3) Writing of SM Information to Memory Card 200 by Software-Writing Device 100e

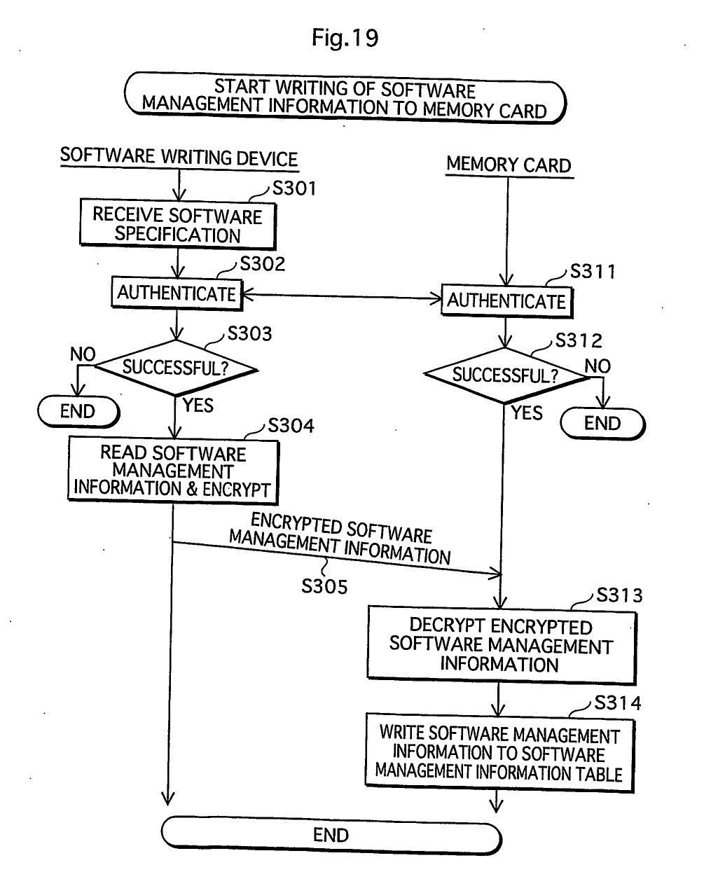

The writing of SM information in memory card 200 by software-writing device 10e is described below using the flowchart shown in FIG. 19. Prior to the writing, memory card 200 is mounted on software-writing device 10e by the operator of device 10e.

Control unit 114 receives a specification of software from input unit 115 as the result of an operator operation (step S301).

Next, authentication units 111 and 211 perform mutual device authentication via I/O units 101 and 201 (steps S302, S311). If device authentication is not successful (steps S303, S312=NO), software-writing device 10e and memory card 200 end the processing.

If device authentication is successful (step S303=YES), encryption unit 118 reads SM information that includes a soft ID identifying the specified software from SM table 121, performs encryption algorithm E3 on the read SM information using a session key received from authentication unit 111 to generate encrypted SM information (step S304). Unit 118 then outputs the encrypted information to memory card 200 via I/O unit 101 (step S305).

If device authentication is successful (step S312=YES), decryption unit 212 receives the encrypted SM information via I/O unit 201 (step S305), performs decryption algorithm D3 on the encrypted SM information using a session key received from authentication unit 211 to generate SM information, and outputs the generated SM information to judgment unit 214 (step S313).

Judgment unit 214 receives the SM information from decryption unit 214, and adds (writes) the received SM information to SMI table 213 (step S314).

(4) Transmission of Encrypted Software by Software-Writing Device 100e

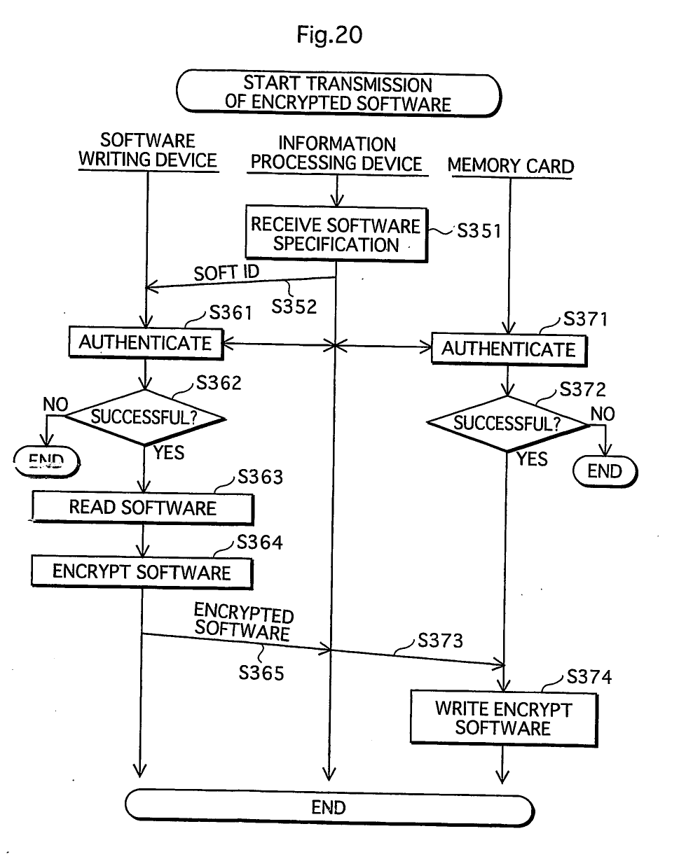

Operations performed when transmitting encrypted software from software-writing device 100e to memory card 200 via Internet 20 and information-processing device 300e are described below using the flowchart shown in FIG. 20.

Prior to the transmitting, memory card 200 is mounted on information-processing device 300e by the operator of device 300e.

Control unit 321 in device 300e receives a specification of software from input unit 323 as the result of an operator operation (step S351), and transmits the soft ID identifying the specified software to software-writing device 100e via transmit/receive unit 302 and Internet 20. Encryption unit 112 of software-writing device 100e receives the soft ID via transmit/receive unit 102 (step S352).

Authentication units 111 and 211 perform mutual device authentication via transmit/receive unit 102, Internet 20, information-processing device 300e, and I/O unit 201 (steps S361, S371). If device authentication is not successful (steps S362, S372=NO), device 300e and memory card 200 end the processing.

If device authentication is successful (step S362=YES), encryption unit 112 reads SM information that includes the received soft ID from SM table 121, and extracts a soft key from the read SM information. Unit 112 then reads software identified by the received soft ID from information storage unit 113 (step S363), performs encryption algorithm E1 on the read software using the extracted soft key as a key to generate encrypted software (step S364), and transmits the encrypted software to information-processing device 300e via transmit/receive unit 102 and Internet 20 (step S365). Transmit/receive unit 302 of device 300e receives the encrypted software, and outputs the encrypted software to memory card 200 via I/O unit 301 (step S373).

I/O unit 201 receives the encrypted software (step S373), and writes the encrypted software to first storage area 221 in information storage unit 220 (step S374).

(5) Related Matters

Although software-writing device 100e and information-processing device 300e are described in variation 4 as being connected to Internet 20, they may be connected to a network other than Internet.

Furthermore, although in variation 4 mutual device authentication is performed prior to transmission of encrypted software from software-writing device 100e to memory card 200, it is possible to omit the authentication process.

6. Variation 5

The following description relates to a software-management system 10f as a variation of software-management system 10 shown in FIG. 1.

6.1 Structure of Software-Management System 10f

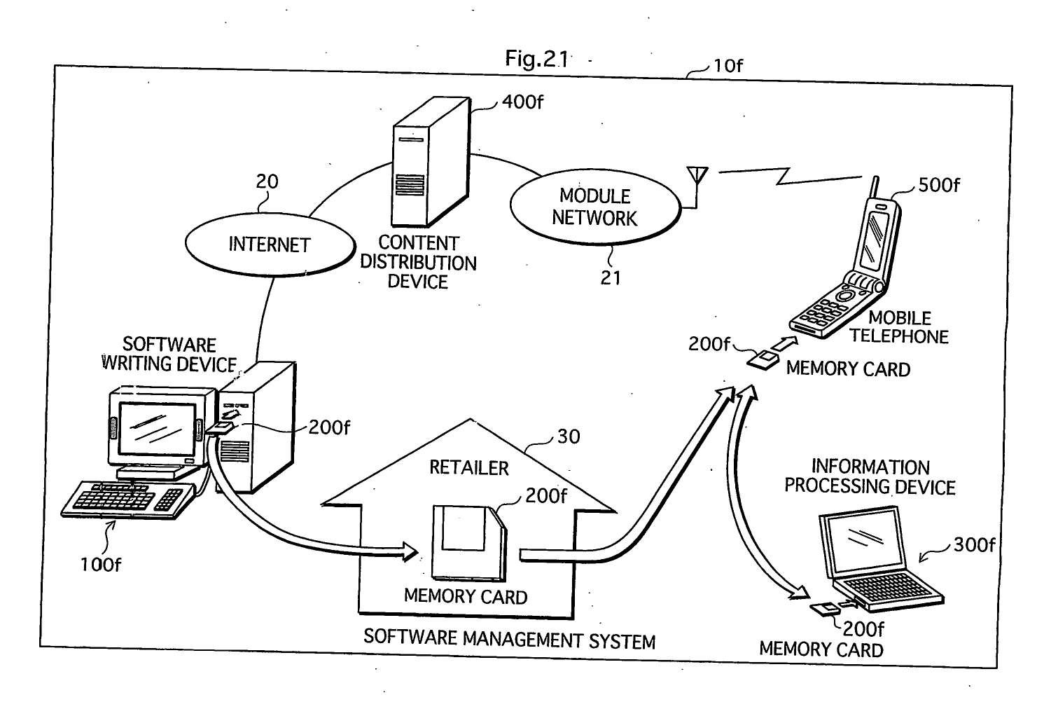

Software-management system 10f is, as shown in FIG. 21, constituted from a software-writing device 100f, a portable memory card 200f, an information-processing device 300f, a content-distribution device 400f, and a mobile telephone 500f. Devices 100f and 400f are connected to Internet 20, while devices 500f are connected via mobile network 21.

Software-writing device 100f stores various kinds of software. This software includes contents such as movies and music, and computer programs such as video playback programs describing playback procedures for video and the like. Memory card 200f is mounted on software-writing device 10f, and device 100f encrypts software and writes the encrypted software to memory card 200f.

Memory card 200f having encrypted software written thereon is retailed by a retailer 30, and users obtain memory card 200f by purchasing the memory card.

Software-writing device 100f also stores SM information that includes various kinds of license information. This license information determines conditions and the like to be upheld when a user uses contents, computer programs and the like. Device 100f transmits SM information to content-distribution device 400f secretly so as not to revealed the SM information to third parties. Device 400f secretly receives and stores the SM information.

A user mounts the obtained memory card 200f on mobile telephone 500f, and as the result of a user operation, mobile telephone 500f requests content-distribution device 400f via mobile network 500f for transmission of SM information.

Content-distribution device 400f, in response to the request from mobile telephone 500f, transmits SM information that includes license information to the mobile telephone, either for compensation or gratuitously. Mobile telephone 500f receives the SM information, and writes the received SM information to memory card 200f.

The user then removes memory card 200f having SM information written thereon from mobile telephone 500f, and mounts the memory card on information-processing device 300f.

Information-processing device 300f, as the result of a user operation, internally installs (stores) encrypted software stored on memory card 201f, in accordance with the license information includes in the SM information stored on the memory card. Here, when the encrypted software is a computer program, “installation” is generally referred to as program installation. On the other hand, when the encrypted software is a content, “installation” is generally referred to as content duplication. Device 300f then decrypts the encrypted software stored internally in accordance with a user instruction to generate software, and uses the generated software. Here, when the software is a content, “use” means playback of the content. On the other hand, when the software is a computer program, “use” means execution of the program.

Also, information-processing device 300f reads encrypted software from memory card 200f in accordance with the license information included in the SM information stored on the memory card, decrypts the encrypted software to generate software, and uses the generated software. Here, “use” is as described above.

Software-writing device 100f, memory card 200f, and information-processing device 300f included in software-management system 10f have respectively similar structures to software-writing device 100, memory card 200, and information-processing device 300 included in software-management system 10.

The following description relates to the elements constituting software-management system 10f, focusing on the differences with devices 100, 200 and 300.

6.2 Software-Writing Device 100f

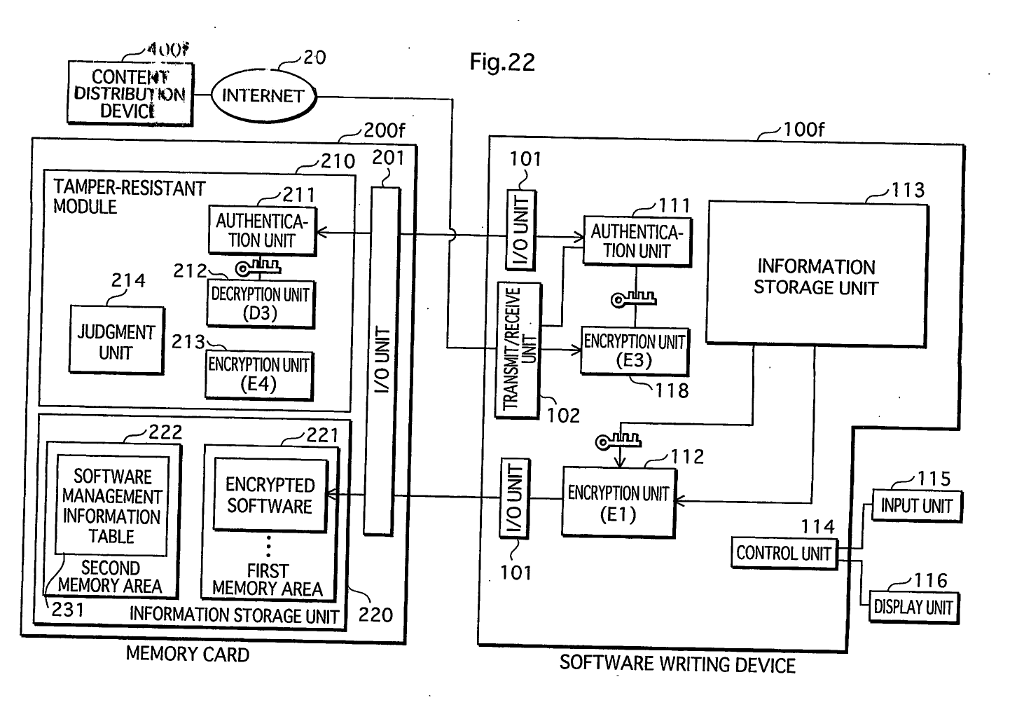

Software-writing device 100f is, as shown in FIG. 22, constituted from an authentication unit 111, an encryption unit 112, an information storage unit 113, a control unit 114, an encryption unit 118, a transmit/receive unit 102, and an I/O unit 101. An input unit 115 and a display unit 116 are connected to device 100f.

Software-writing device 100f secretly transmits all of the stored SM information to content-distribution device 400f via Internet 20. Device 100f also encrypts stored software in response to an operator operation, and writes the encrypted software to memory card 200f mounted on software-writing device 100f.

The following description focuses on the differences with the elements of software-writing device 100.

(1) Information Storage Unit 113

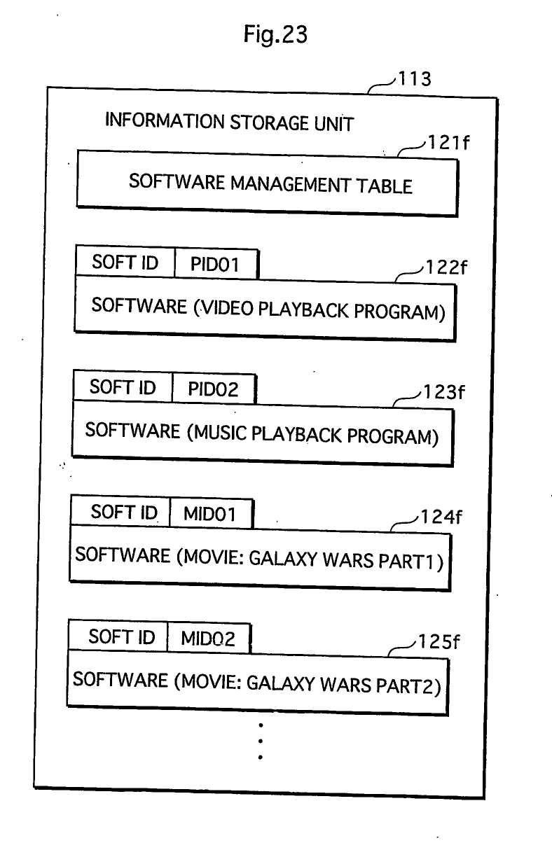

Information storage unit 113, as shown in FIG. 23, securely stores a software management (SM) table 121f, and software 122f, 123f, 124f, 125f, . . . , instead of SM table 121 and software 122, 123, 124, . . . .

Software 122f and 123f are computer programs that each includes a plurality of computer instructions. Specifically, software 122f is a video playback program that includes a procedure for playing and displaying/outputting video contents constituted from video and audio, while software 123f is an audio playback program that includes a procedure for playing and outputting music.

Software 124f and 125f are contents comprising digitalized movies. Specifically, software 124f and 125f are compression-coded data comprising video and audio that has been digitalized and compression coded using a Moving Picture Experts Group (MPEG) 2 standard, while other software are, for example, compression-coded data comprising music digitalized and compression coded using an MP3 (MPEG-1 Audio Layer 3) standard.

Software 122f, 123f, 124f, 125f, . . . , are identified respectively by soft IDs PID01, PID02, PID03, PID04, PID05, . . . .

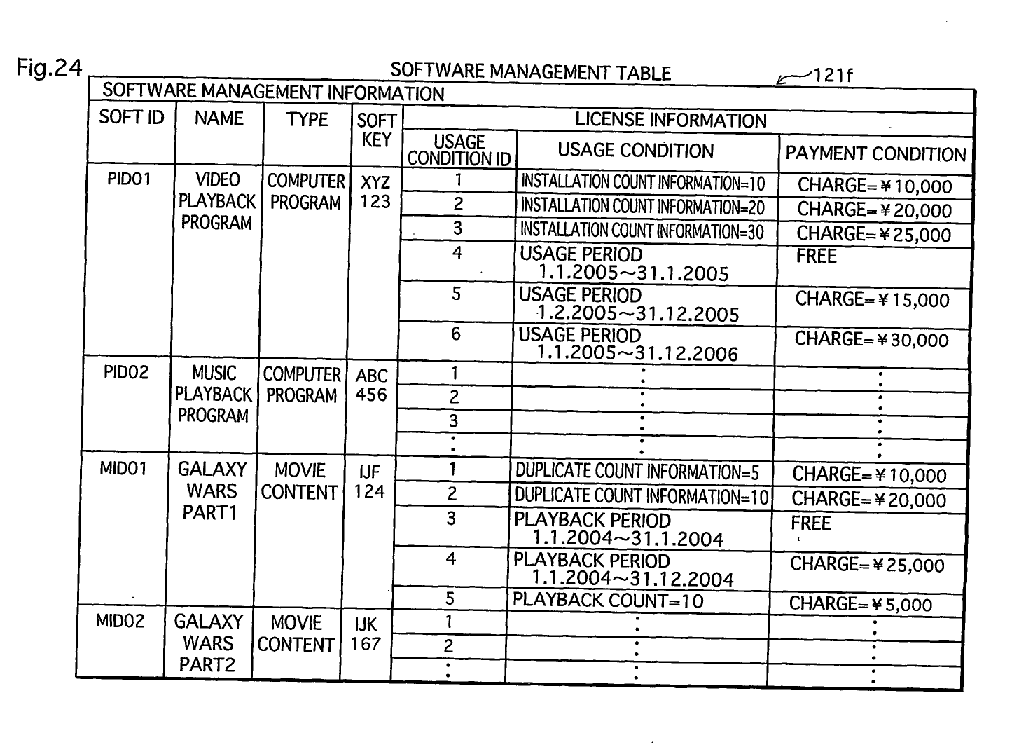

SM table 121f, as shown in FIG. 24, is a data table that includes plural pieces of SM information.

The pieces of SM information correspond one-to-one with pieces of software, and include a soft ID, a name, a type, a soft key, and one or pieces of license information. Each piece of license information includes a usage condition ID, a usage condition, and a payment condition.

Soft IDs, each having a 64-bit length, are identification numbers for uniquely identifying corresponding software.

Names are the identification names of corresponding software.

Type shows whether corresponding software is a computer programs or a content, being a digital copyrighted work.

Soft keys, each having a 56-bit length, are encryption keys used when encrypting corresponding software.

Each usage condition IDs is an identification number for uniquely identifying license information that includes the usage condition ID.

The usage condition is information showing usage configurations and specific conditions permitted of corresponding software. Exemplary configurations include (i) installing programs, using programs, duplicating contents, or playing contents a specified number of times, and (ii) using programs or playing contents within a specified time period. Examples of specific conditions include the above specified counts and periods.

In the case of the installation count information being “10”, for example, the user is permitted a maximum of ten installations of the software (computer program), and in the case of the duplication count information being “5”, the user is permitted a maximum of five duplications of the software (content).

Also, with the usage condition, for example, in the case of the usage period being “1.1.2005˜31.1.2005”, use of the software is permitted from Jan. 1, 2005 until Jan. 31, 2005, whereas in the case of the usage period being “1.1.2004˜31.12.2004”, playback of the software is permitted from Jan. 1, 2004 until Dec. 31, 2004.

The payment condition shows the price that the user is liable to pay for use of software according to the corresponding usage conditions.

For example, in the case of the charge in the payment condition being “¥10,000”, the user has to pay 10,000 yen for use of the software, whereas in the case of the payment condition being “free”, no payment is required to use the software.

In this way, one or more different pieces of license information are prepared for each piece of software according to usage configurations of the software, the payable charges varying respectively. The user is thus able to select the desired usage configuration.

(2) Input Unit 115

Input unit 115 further operates as follows.

Input unit 115 receives an instruction to transmit SM information from the operator of software-writing device 100f, and outputs the received instruction to control unit 114.

(3) Control Unit 114

Control unit 114 operates as follows, instead of outputting the received soft ID to encryption unit 118 and instructing unit 118 to encrypt SM information and write the encrypted SM information to memory card 200f.

Control unit 114 receives an instruction to transmit SM information from input unit 115, and instructs authentication unit 111 to perform device authentication with content-distribution device 400f. Unit 114 also receives information from authentication unit 111 showing authentication to be successful or unsuccessful.

On receipt of authentication-successful information from authentication unit 111, control unit 114 instructs encryption unit 118 to encrypt all of the pieces of SM information and transmit the encrypted SM information to content-distribution device 400f.

On receipt of authentication-unsuccessful information from authentication unit 111, control unit 114 terminates processing relating to transmission of SM information.

(4) Authentication Unit 111

Authentication unit 111 further operates as follows.

Authentication unit 111 receives an instruction from control unit 114 to perform device authentication with content-distribution device 400f. On receipt of the instruction, unit 111 performs a challenge-response type of mutual device authentication with content-distribution device 400f. Unit 111 then generates information showing authentication to be successful or unsuccessful depending on the device authentication result, and outputs the generated information to control unit 114.

If authentication is successful, authentication unit 111 generates a session key and outputs the generated session key to encryption unit 118.

(5) Encryption Unit 118

Encryption unit 118 operates as follows, instead of receiving a soft ID and an encryption instruction, reading SM information that includes the received soft ID, encrypting the read SM information using a session key, and outputting the encrypted information to memory card 200f.

Encryption unit 118 receives an instruction from control unit 114 to encrypt and transmit all of the pieces of SM information. Unit 118 also receives the session key from authentication unit 111.

On receipt of the encryption instruction from control unit 114, encryption unit 118 reads all of the SM information from SM table 121f, performs encryption algorithm E3 on the read SM information using the session key received from authentication unit 111 to generate pieces of encrypted SM information equal in number to the read SM information. Unit 118 then transmits the encrypted SM information to content-distribution device 400f via transmit/receive unit 102 and Internet 20.

(6) Transmit/Receive Unit 102

Transmit/receive unit 102 is connected to Internet 20, and transmits/receives information with an external device connected via Internet 20 and units 118 and 111.

Here, the external device is content-distribution device 400f.

6.3 Content-Distribution Device 400f

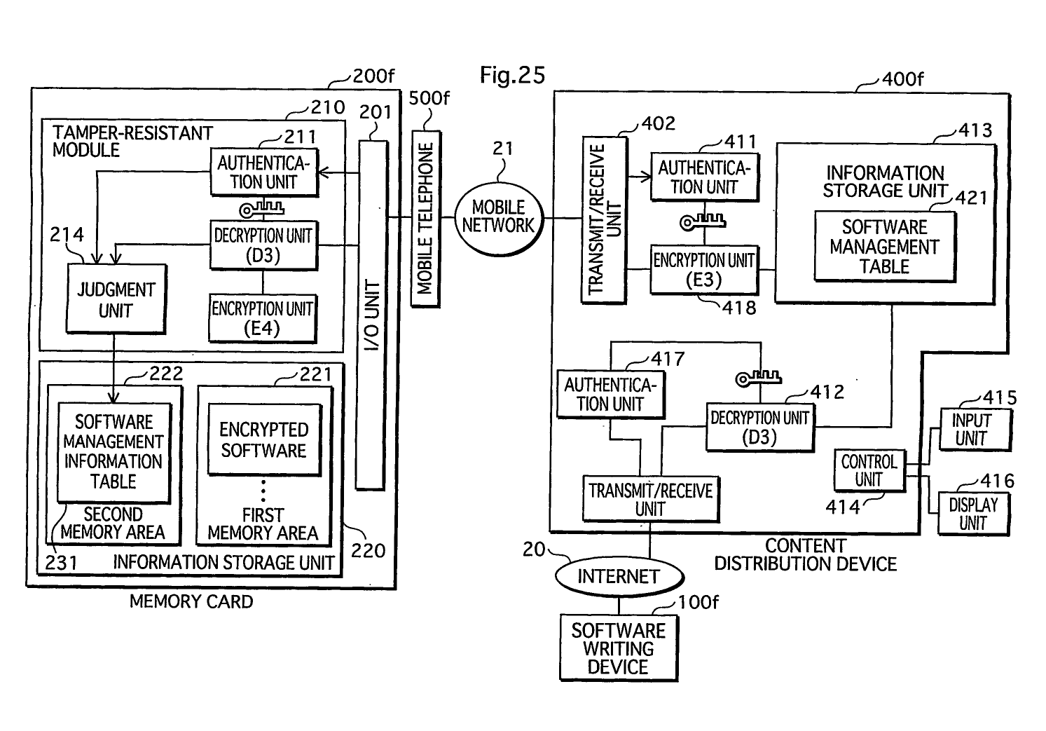

Content-distribution device 400f is, as shown in FIG. 25, constituted from a transmit/receive unit 402, an authentication unit 411, an information storage unit 413, a control unit 414, a decryption unit 412, an authentication unit 417, and an encryption unit 418. An input unit 415 and a display unit 416 are connected to device 400f.

Content-distribution device 400f is, the same as software-writing device 100, a computer system constituted from a microprocessor, a ROM, a RAM, a hard disk unit, and the like. Also, input unit 415 is specifically a keyboard, and display unit 416 is specifically a display unit. A computer program is stored in the RAM or on the hard disk unit. Device 400f carries out functions as a result of the microprocessor operating in accordance with the computer program.

(1) Information Storage Unit 413

Information storage unit 413 has a software management (SM) table 421.

SM table 421 includes areas for storing one or more pieces of SM information. Description of SM information, being the same the SM information shown in FIG. 24, is omitted here.

(2) Transmit/Receive Unit 402

Transmit/receive unit 402 is connected to software-writing device 100f via Internet 20, and to memory card 200f via mobile network 21 and mobile telephone 500f.

Transmit/receive unit 402 conducts information transmission/reception between software-writing device 100f and authentication unit 417, decryption unit 412, and control unit 414.

Transmit/receive unit 402 also conducts information transmission/reception between mobile telephone 500f and control unit 414 authentication unit 417, and encryption unit 418.

Also, transmit/receive unit 402 receives information from control unit 414 showing authentication to be successful or unsuccessful. On receipt of authentication-successful information, unit 402 continues to transmit/receive, whereas on receipt of authentication-unsuccessful information, unit 402 terminates any further transmission/reception.

(3) Authentication Unit 417

Authentication unit 417, when instructed by control unit 414, performs a challenge-response type of mutual device authentication with software-writing device 100f via transmit/receive unit 402 and Internet 20. Unit 417 generates information showing authentication to be successful or unsuccessful depending on the device authentication result, and outputs the generated information to control unit 414.

If device authentication is successful, authentication unit 417 generates a session key, and outputs the generated session to decryption unit 412.

(4) Decryption Unit 412

Decryption unit 412 receives the session key from authentication unit 417.

Decryption unit 412 also receives one or more pieces of encrypted SM information from software-writing device 100f via Internet 20 and transmit/receive unit 402, performs decryption algorithm D3 on each piece of encrypted SM information using the received session key to generate pieces of SM information equal in number to the encrypted SM information, and writes the generated SM information to SM table 421 in information storage unit 413.

In this way, SM table 421 ends up with the same content as SM table 121f shown in FIG. 24.

(5) Authentication Unit 411

Authentication unit 411, when instructed by control unit 414, performs a challenge-response type of mutual device authentication with memory card 200f via mobile network 21 and mobile telephone 500f. Unit 411 then generates information showing authentication to be successful or unsuccessful depending on the device authentication result, and outputs the generated information to control unit 414.

If device authentication is successful, authentication unit 411 generates a session key, and outputs the generated session to encryption unit 418.

(6) Encryption Unit 418

Encryption unit 418 receives a session key from authentication unit 411, and receives SM information and an instruction showing to encrypt the SM information from control unit 414.

On receipt of the instruction, encryption unit 418 performs encryption algorithm E3 on the received SM information using the session key received from authentication unit 411 to generate encrypted SM information. Unit 418 then outputs the encrypted SM information to memory card 200f via transmit/receive unit 402, mobile network 21 and mobile telephone 500f.

(7) Control Unit 414

Control unit 414 receives, from software-writing device 100f via Internet 20, transmission-start information showing to start transmission of the SM table. On receipt of the transmission-start information, unit 414 instructs authentication unit 411 to perform device authentication.

Control unit 414 also receives information from authentication unit 417 showing authentication to be successful or unsuccessful. On receipt of authentication-successful information, unit 414 instructs transmit/receive unit 402 to continue transmitting/receiving. On receipt of authentication-unsuccessful information, unit 414 instructs unit 402 to terminate transmission/reception.

Control unit 414 receives information from authentication unit 411 showing authentication to be successful or unsuccessful. On receipt of authentication-successful information, unit 414 reads all of the SM information from SM table 421 stored in information storage unit 413, extracts soft IDs, names, types, and all of the license information from the read SM information, and generates display information constituted from the extracted soft IDs, names, types, and license information. In this way, unit 414 generates a software list that includes pieces of software display information equal in number to all of the SM information read from SM table 421. Unit 414 then transmits the generated software list to mobile telephone 500f via transmit/receive unit 402 and mobile network 21.

Control unit 414 receives a soft ID and a usage condition ID from mobile telephone 500f via mobile network 21 and transmit/receive unit 402. Unit 414 then reads license information shown by the received soft ID and usage condition ID from SM table 421, extracts the payment condition from the read license information, and calculates the amount shown by the extracted payment condition as the charge. Unit 414 then transmits charge information showing the calculated charge to mobile telephone 500f via mobile network 21. Unit 414 and mobile telephone 500f then perform charge account processing. The charge account processing may be performed using any technology that is currently used in content services available via mobile telephone. One example is to charge for usage of contents together with the telephone usage charge. Another example is to charge to a user's credit card for usage of contents. Being well-known technology, a detailed description of the charge account processing is omitted here.

When the charge account processing has ended, control unit 414 reads SM information that includes the soft ID from SM table 421, and extracts license information that includes the usage condition ID from the read SM information. Next, unit 414 generates a contract ID identifying SM information to be newly generated, newly generates SM information constituted from the generated contract information, the soft ID, name and type included in the read SM information, and the extracted license information, and outputs the generated SM information to encryption unit 418. Unit 414 also controls encryption unit 418 to encrypt the SM information.

6.4 Mobile Telephone 500f

Mobile telephone 500f is constituted to include an antenna, a wireless reception unit, a wireless transmission unit, a baseband-signal processing unit, a control circuit, a receiver, a transmitter, a display unit, an input unit having a plurality of keys, and an input/output (I/O) unit that inputs/outputs information with memory card 200f. Mobile telephone 500f transmits/receives information with other devices via mobile network 21.

Memory card 200f is mounted in mobile telephone 500f by a user.

Mobile telephone 500f receives a request to acquire license information as the result of a user operation, and transmits the received request to content-distribution device 400f via mobile network 21.

Mobile telephone 500f receives a software list from content-distribution device 400f via mobile network 21, and displays the received software list. Mobile telephone 500f then receives a selection by the user of one piece of software from the displayed software list, and receives a selection of one piece of license information. Mobile telephone 500f extracts the soft ID identifying the selected software and the usage condition ID identifying the selected license information from the software list, and transmits the extracted soft ID and usage condition ID to content-distribution device 400f via mobile network 21.

Mobile telephone 500f also receives charge information from content-distribution device 400f via mobile network 21, and performs charge account processing with device 400f based on the received charge information.

Mobile telephone 500f further receives encrypted SM information from content-distribution device 400f via mobile network 21, and outputs the encrypted SM information to memory card 200f.

6.5 Memory Card 200f

Memory card 200f, which has the same structure as memory card 200 and is, as shown in FIGS. 22, 25 and 27, constituted from a tamper-resistant module 210, an information storage unit 220, and an input/output (I/O) unit 201. Tamper-resistant module 210 is constituted from an authentication unit 211, a decryption unit 212, an encryption unit 213, and a judgment unit 214. Information storage unit 220 is constituted from a first storage area 221 and a second storage area 222.

The following description focuses on the differences with memory card 200.

(1) I/O Unit 201

I/O unit 201 receives a list request from information-processing device 300f and outputs the received request to judgment unit 214.

(2) Judgment Unit 214

Generation of Software List

Judgment unit 214 receives a list request from I/O unit 201. On receipt of the list request, unit 214 reads all of the SM information from SMI table 231 in second storage area 222 of information storage unit 220. Unit 214 then judges whether installation, playback or execution of software is possible, using the usage condition included in each of the read pieces of SM information.

Specifically, judgment unit 214 judges installation to not be permitted if the installation count information in the usage condition is “0”, and to be permitted if “1” or more. Similarly, unit 214 judges duplication to not be permitted if the duplication count information in the usage condition is “0”, and to be permitted if “1” or more. Also, unit 214 judges execution to be possible if the present time is within the usage period in the usage condition, and not possible if not within the usage period. Similarly, unit 214 judges playback to be possible if the present time is within the playback period in the usage condition, and not possible if not within the playback period.

If judged in the negative (i.e. not possible) in any of the above, the read SM information is discarded. Here, it should be noted that the present invention is not limited to this specific structure. For example, even if judged in the negative, software display information may be created from read SM information. Yet, to differentiate from software permitted to be installed, played or executed, the software display information generated herein is appended with information indicating that usage of the software is not permitted. A software list including software permitted to be used as well as software not permitted to be used is generated and displayed to users. Users may additionally purchase licenses for desired not-permitted software included in the displayed software list, so that the software is then permitted to be installed, played or executed.

If judge possible, judgment unit 214 extracts a soft ID, name, type and usage condition from the read SM information, and generates software display information constituted from the extracted soft ID, name, type and usage condition.

In this way, software display information is generated that relates pieces of the read SM information with respect to which judgment unit 214 judged in the affirmative (i.e. installation, duplication, usage or playback possible), as described above. Unit 214 generates a software list that includes the generated pieces of software display information, and outputs the generated list to information-processing device 300f via I/O unit 201.

Software Output Judgment

Judgment unit 214 judges whether the classification received from decryption unit 212 is one of program installation or uninstallation and content duplication or deletion.

If the received classification is judged to be program uninstallation or content deletion, judgment unit 214 adds “1” to the installation or duplication count information included in the SM information, and overwrites the SM information in SMI table 231 with the obtained value to update the installation or duplication count information.

Judgment unit 214 checks whether the device ID received received from duplication unit 212 is included in SM information received from second storage area 222.

If the device ID is not included, judgment unit 214 determines the request to be for program installation (or content duplication) to anew information-processing device, and checks the installation (or duplication) count included in the SM information. If the installation (or duplication) count is “1” or more unit 214 judges installation (or duplication) to be permitted. At this time, unit 214, in addition to adding (writing) the device ID received from decryption unit 212 to the SM information read from second storage area 222, writes SM information in which the installation (or duplication) count has been reduced by “1” to updated the count, to second storage area 222. If the installation (or duplication) count is zero, unit 214 judges installation (or duplication) to not be permitted.

If the received device ID is included, judgment unit 214 determines the request to be for program reinstallation (or content reduplication) to an information-processing device that has already installed (or duplicated) the software.

Software Execution/Playback Judgment

Judgment unit 214 receives a soft ID from decryption unit 212, reads SM information corresponding to the received soft ID from second storage area 222, and judges whether to permit decryption and execution of the encrypted computer program (or decryption and playback of the encrypted content), based on the read SM information.

Judgment unit 214 judges permission as follows.

Judgment unit 214 extracts the usage condition from read SM information, and judges whether the extracted usage condition shows “playback count information” or “playback period”. If the usage condition shows “playback count information”, unit 214 judges whether the playback count included in the usage condition is “1” or more, and if judged to be “1” or more, unit 214 reduces the playback count by 1 and judges playback to be permitted. If the playback count is “0”, unit 214 judges playback to not be permitted.

If the usage condition shows “playback period”, unit 214 acquires the present date-time, and judges whether the present date-time is within the usage period. If within the playback period, unit 214 judges playback to be permitted. If outside the playback period, unit 214 judges playback to not be permitted.

While the above judgment relates to whether to permit decryption/playback of an encrypted content, the judgment as to whether to permit decryption/execution of an encrypted computer program is performed in the same manner. In the case of an encrypted computer program, the playback count is replaced by an “installation count”, and the playback period replaces an “installation period”.

If judged not to permit execution (or playback), judgment unit 214 transmits a permission-denied message showing not permitted to information-processing device 300f, after which memory card 200f terminates the processing.

If judged to permit execution (or playback), judgment unit 214 transmits the soft key included in the SM information to encryption unit 213.

(3) Encryption Unit 213

Encryption unit 213 receives the soft key from judgment unit 214, encrypts the received soft key using a session key received from authentication unit 211 to generate an encrypted soft key, and transmits the encrypted soft key to information-processing device 300f via I/O unit 201.

(4) Decryption Unit 212

Decryption unit 212 receives a session key from authentication unit 211, decrypts an encrypted soft ID received from information-processing device 300f using the received session key, and outputs the generated soft ID to judgment unit 214.

(5) SMI Table 231

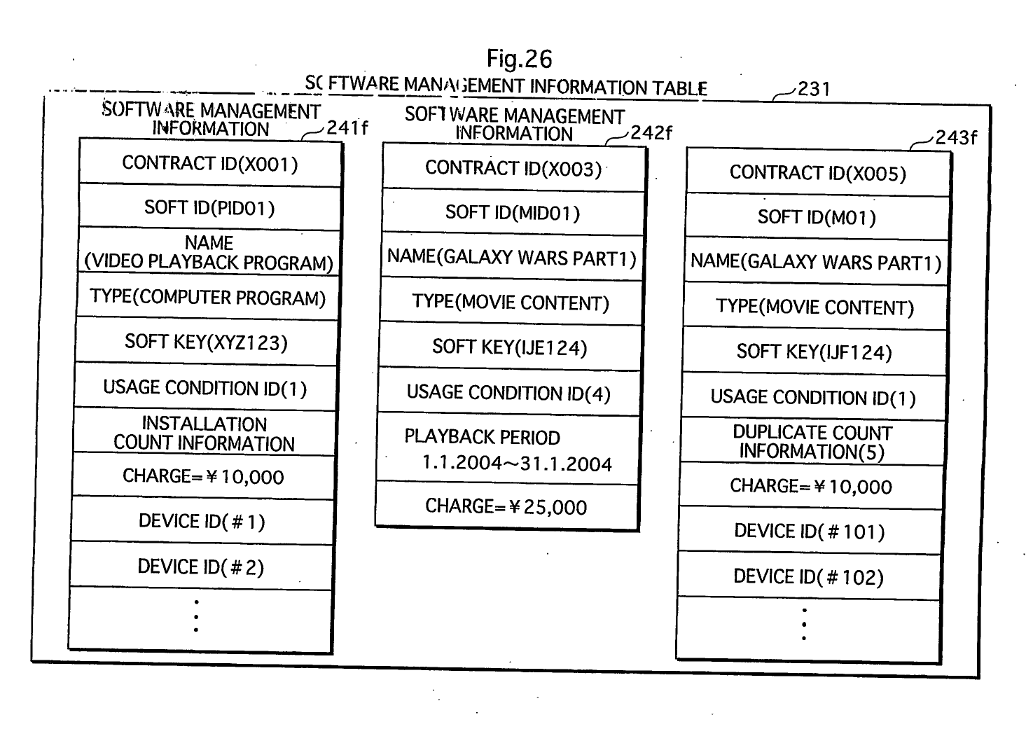

SMI table 231 stores, as shown in FIG. 26, plural pieces of SM information 241f, 242f, and 243f.

SM information 241f includes, as shown in FIG. 26, a contract ID, a soft ID, a name, a type, a soft key, a usage condition ID, installation count information, a charge, and a plurality of device IDs.

SM information 242f includes, as shown in FIG. 26, a contract ID, a soft ID, a name, a type, a soft key, a usage condition ID, a playback period, and a charge.

SM information 243f includes, as shown in FIG. 26, a contract ID, a soft ID, a name, a type, a soft key, a usage condition ID, duplication count information, a charge, and a plurality of device IDs.

6.6 Information-Processing Device 300f

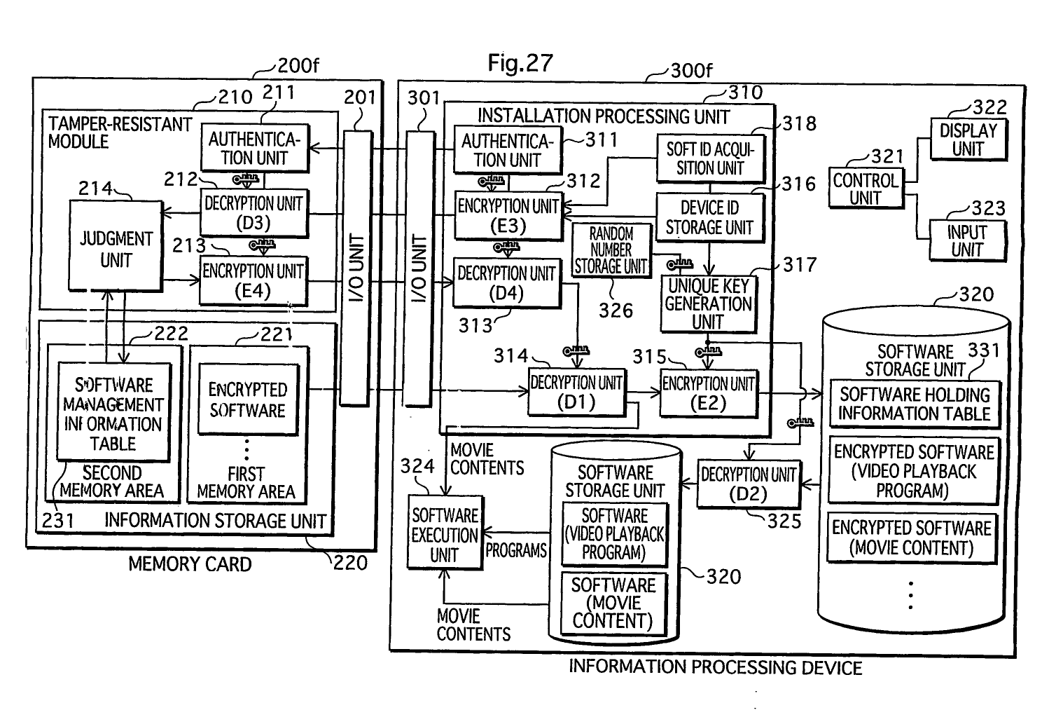

Information-processing device 300f is, as shown in FIG. 27, constituted from an installation-processing unit 310, a software storage unit 320, a control unit 321, a display unit 322, an input unit 323, a software execution unit 324, a decryption unit 325, and an input/output (I/O) unit 301. Installation-processing unit 310 is in turn constituted from an authentication unit 311, an encryption unit 312, decryption units 313 and 314, an encryption unit 315, a device ID storage unit 316, a unique key generation unit 317, a soft ID acquisition unit 318, and a random number storage unit 326.

The elements of information-processing device 300f are similar to those of information-processing device 300. The following description focuses on the differences with the elements of device 300.

(1) Software Storage Unit 320

Software storage unit 320 is constituted specifically from a hard disk unit, and includes areas for storing one or more pieces of encrypted software installed from memory card 200f. These areas have encrypted software stored therein.

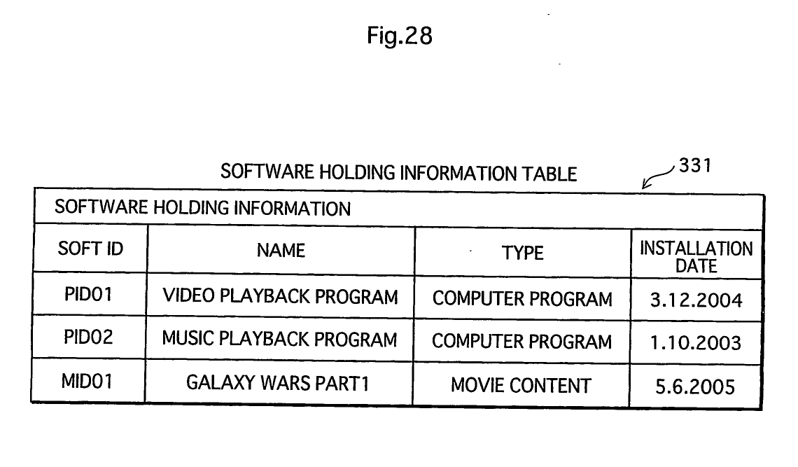

Also, in software storage unit 320, a software holding information (SHI) table shown in FIG. 28 includes an area for storing plural pieces of software holding (SH) information. SH information, which is information showing encrypted software already stored in SHI table 320, is constituted from a soft ID, a name, a type, and an installation date. The soft ID is an identification number identifying the encrypted software. The name is the identification names of the encrypted software. Type is information showing whether the encrypted software is a computer program or a content. The installation date shows the date (day/month/year) on which the encrypted software was written to software storage unit 320.

Software storage unit 320 also includes an area for temporarily storing software generated as a result of decrypting encrypted software.

(2) Input Unit 323

Input unit 323 receives an input relating to one of the various operation classifications from the user. Here, the various operation classifications show: the installation of an encrypted computer program stored on memory card 200f, the uninstallation of an encrypted computer program, the duplication of an encrypted content stored on memory card 200f, the deletion of an encrypted content, the decryption/execution of an encrypted program, and the decryption/playback of an encrypted content. Unit 323 outputs the classification to which the received input relates to control unit 321.

Input unit 323 also receives a selection from the user of one of the pieces of software display information displayed as a software list, extracts the soft ID from the selected software display information, and outputs the extracted soft ID to control unit 321.

(3) Control Unit 321

Control unit 321 receives the classification from input unit 323, and judges whether the received classification shows the uninstallation of an encrypted program, the deletion of an encrypted content, or another operation.

(i) If judged that received classification is one of uninstalling an encrypted program and deleting an encrypted content, control unit 321 reads all of the SH information from SHI table 331 stored in software storage unit 320, generates software display information constituted from the soft ID, name, type, and installation date included in the read SH information, generates a software list that includes pieces of software display information equal in number to the read SH information, and outputs the generated software list to display unit 322.

(ii) If judged that the received classification shows one of the other operations, control unit 321 outputs, to memory card 200f via I/O unit 301, a list request for output of a software list. Unit 321 receives the software list from memory card 200f via I/O unit 301, and outputs the received list to display unit 322.

Control unit 321 then judges whether the classification received from input unit 323 shows one of installation or uninstallation of an encrypted program, duplication or deletion of an encrypted content, decryption/execution of an encrypted program, and encryption/playback of an encrypted content.

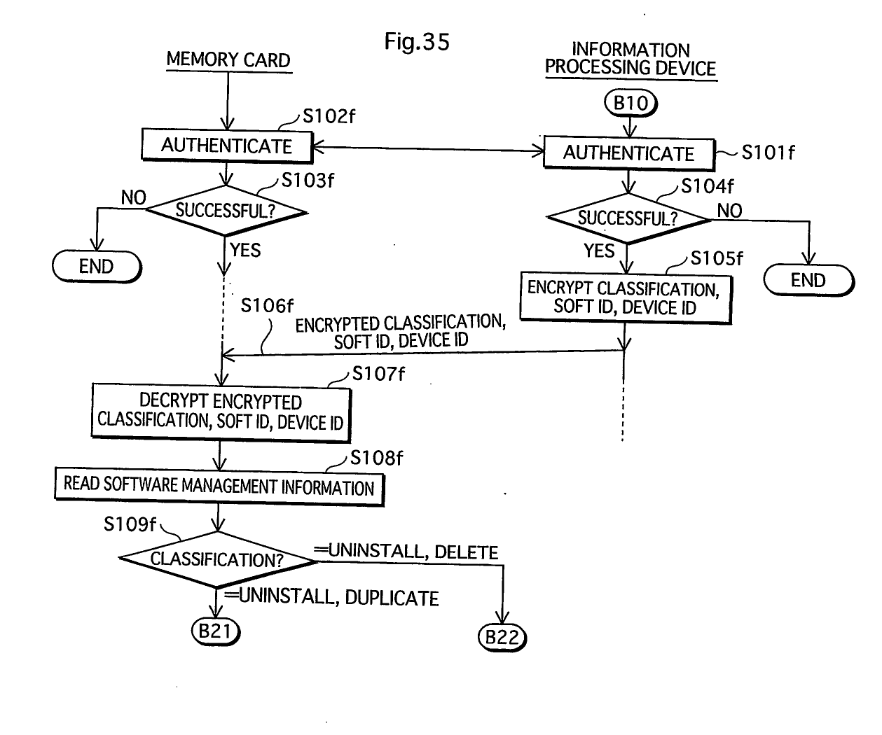

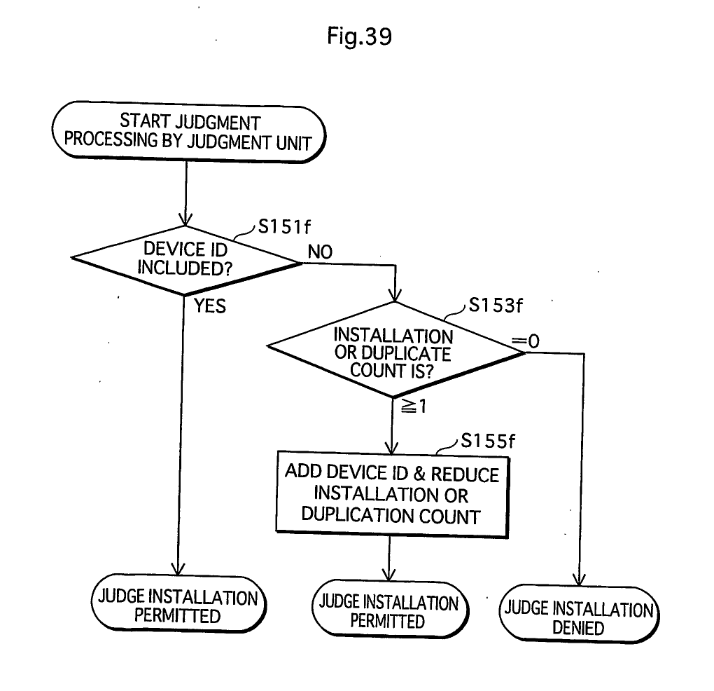

(i) Detailed operations for when the received classification is judged to be one of installation or uninstallation of an encrypted program, and duplication or deletion of an encrypted content are described in a later section (see FIGS. 35-39).

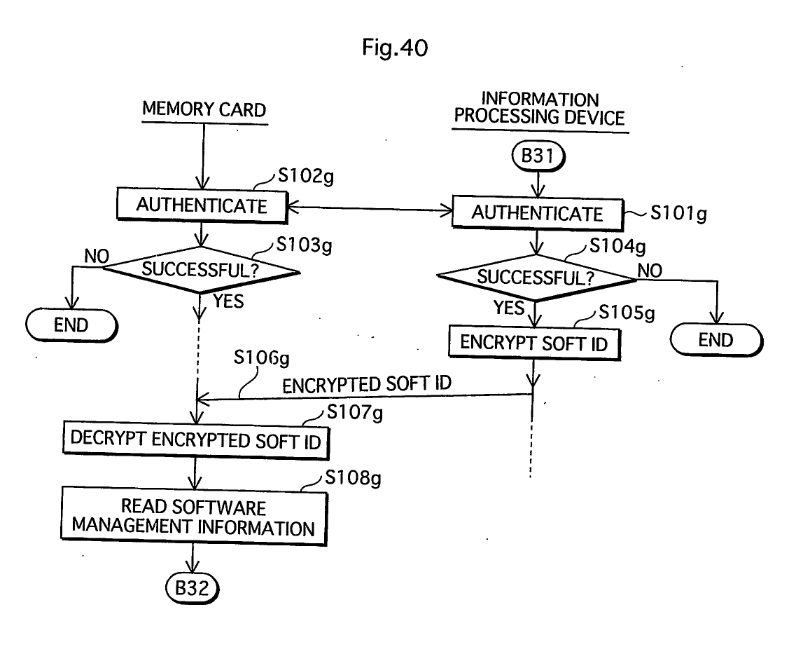

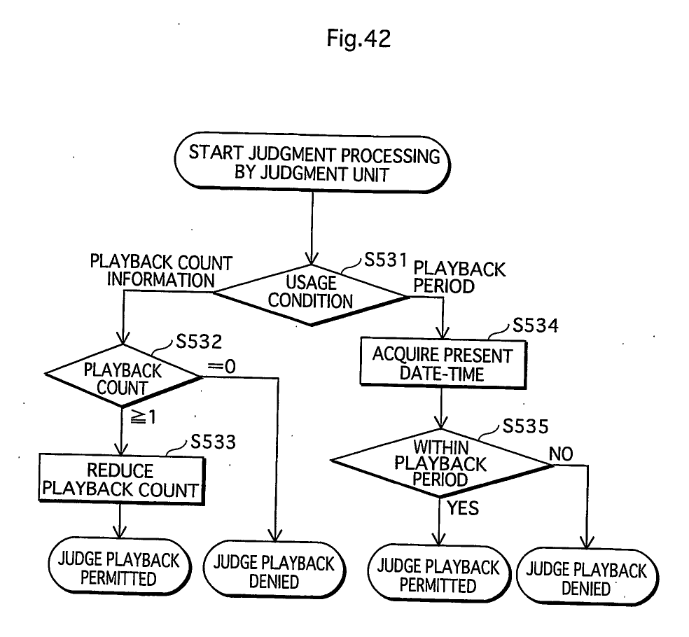

(ii) Detailed operations for when the received classification is judged to be one of decryption/execution of an encrypted program and decryption/playback of an encrypted content are described in a later section (see FIGS. 40-42).

(4) Display Unit 322

Display unit 322 receives a software list from control unit 321, and displays the received list.

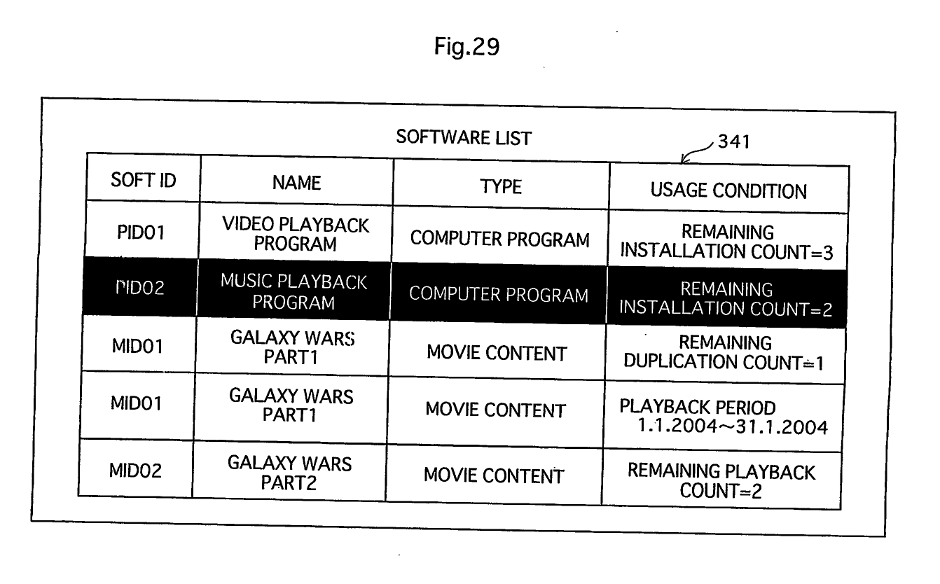

A screen 341 that includes a software list displayed by display unit 322 is shown in FIG. 29. As shown in FIG. 29, screen 341 includes five pieces of software display information that each includes a soft ID, a name, a type and a usage condition.

(5) Encryption Unit 312

Encryption unit 312 receives a session key from authentication unit 311, receives a soft ID from soft ID acquisition unit 318, encrypts the soft ID using the received session key to generate an encrypted soft ID, and transmits the encrypted soft ID to memory card 200f via I/O unit 301.

(6) Decryption Unit 313

Decryption unit 313 decrypts an encrypted soft key received from memory card 200f using a session key received from authentication unit 311 to generate a soft key, and outputs the generated soft key to decryption unit 314.

(7) Decryption Unit 314

Decryption unit 314 receives encrypted software, receives a soft key from decryption unit 313, decrypts the encrypted software using the received soft key, and outputs the decrypted software to software execution unit 324.

(8) Software Execution Unit 324

Software execution unit 324 receives software from decryption unit 314. If the received software is a computer program, unit 324 executes the program, and if a content, unit 324 plays the content.

6.7 Transmission of SM Table

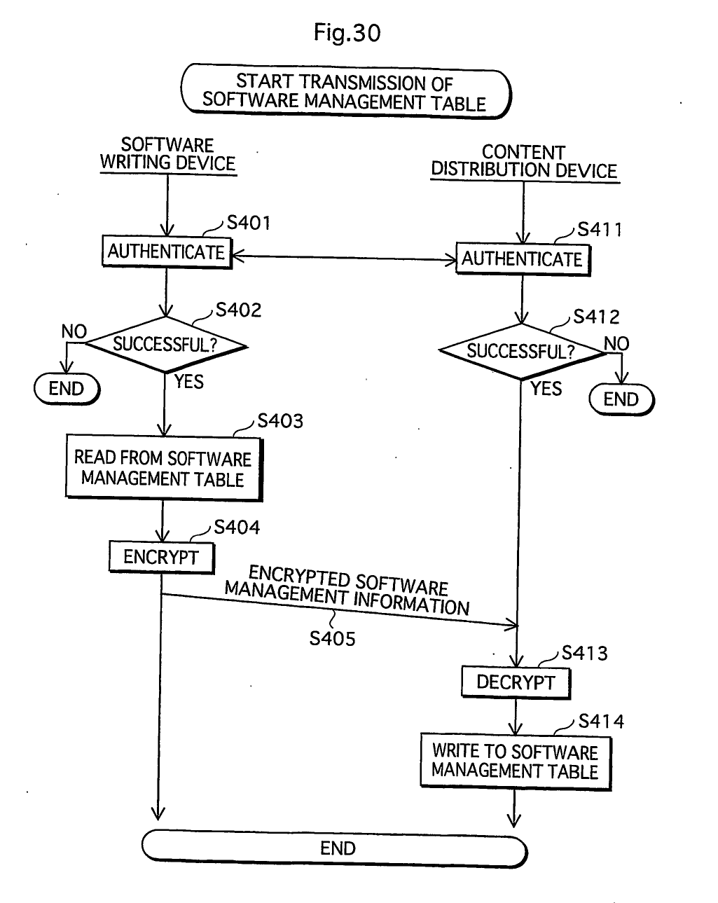

Operations for when transmitting an SM table from software-writing device 100f to content-distribution device 400f are described below using the flowchart shown in FIG. 30.

Note that once the operations for transmitting an SM table are performed for the first time, the operations are performed thereafter regularly or each time SM information of new software is added to the SM table by software-writing device 100f.

Input unit 115 in software-writing device 100f receives an instruction to transmit SM table 121f to content-distribution device 400f as the result of an operation by the device 100f operator, and outputs the received instruction to control unit 114, which receives the instruction and controls authentication unit 111 to perform mutual device authentication with device 400f.

Authentication unit 111 in software-writing device 100f and authentication unit 417 in content-distribution device 400f perform mutual device authentication (steps S401, 411), and if not successful (steps S402, S412=NO), devices 100f and 400f terminate processing to transmit/receive the SM table.

If device authentication is successful (steps S402=YES), encryption unit 118 reads all of the SM information included in SM table 121f stored in information storage unit 113 (step S403), encrypts the read SM information (step S404), and transmits the encrypted SM information to content-distribution device 400f via transmit/receive unit 102 and Internet 20 (step S405).

If device authentication is successful (steps S412=YES), control unit 412 receives encrypted SM information from software-writing device 100f via Internet 20 and transmit/receive unit 402 (step S405), decrypts the encrypted SM information to generate SM information (step S413), and writes the generated SM information to SM table 421 stored in information storage unit 413 (step S414).

In this way, content-distribution device 400f ends up holding an SM table 421 having the same content as SM table 121f stored in software-writing device 100f.

6.8 Writing of Encrypted Software to Memory Card 200f

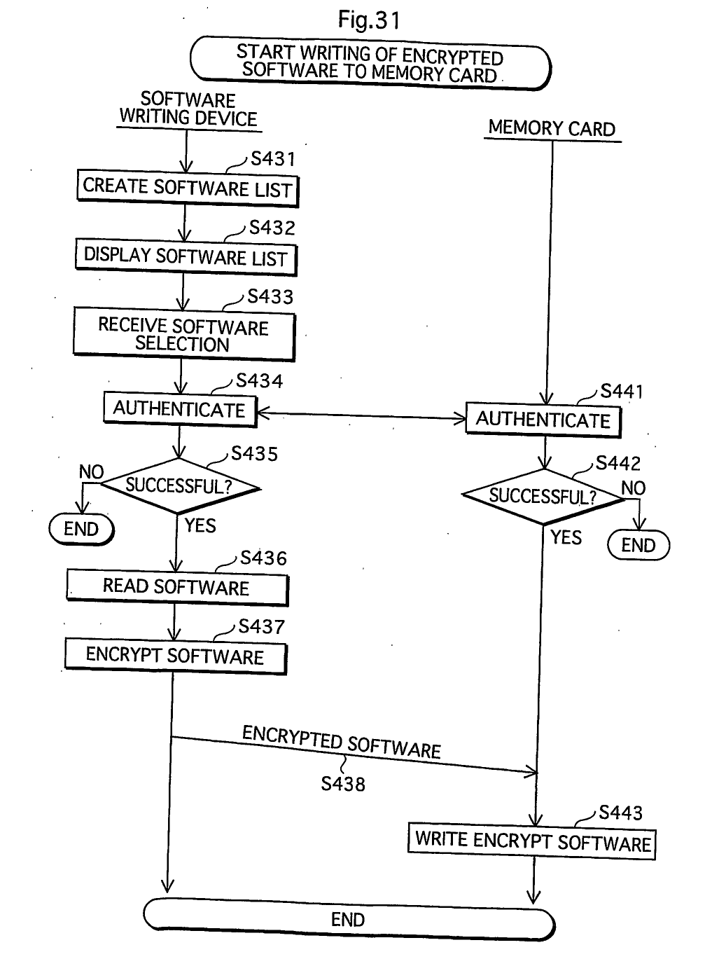

Operations performed by software-writing device 100f to write encrypted software to memory card 200f are described below using the flowchart shown in FIG. 31.

Prior to the writing, memory card 200f is mounted on software-writing device 100f by the operator of device 100f.

Control unit 114 reads all of the SM information included in SM table 121f stored in information storage unit 113, extracts the soft ID, name, type and license information from each pieces of read SM information, and generates a software list that includes pieces of software display information constituted from the extracted soft IDs, names, types and license information, of equal number to the read pieces of SM information (step S431).

Control unit 114 then outputs the generated list to display unit 116, which displays the software list (step S432).

Input unit 115 receives a selection of one of the pieces of software display information from the software list as the result of an operation by the device 100f operator, and outputs the soft ID included in the selected software display information to control unit 114 (step S433).

Authentication units 111 and 211 then perform mutual device authentication. (steps S434, S441), and if not successful (steps S435, S442=NO), software-writing device 100f and memory card 200f terminate the processing.

If device authentication is successful (step S435=YES), encryption unit 112 receives a soft ID from control unit 114, and reads software identified by the received soft ID from information storage unit 113 (step S436), performs encryption algorithm E1 on the read software to generate encrypted software (step S437), and outputs the encrypted software to memory card 200f via I/O unit 101 (step S438).

I/O unit 201 in memory card 200f receives the encrypted software (step S438), and writes the encrypted software to first storage area 221 of information storage unit 220 (step S443).

In this way, software-writing device 100f encrypts stored software and writes the encrypted software memory card 200f.

6.9 Acquisition of License Information

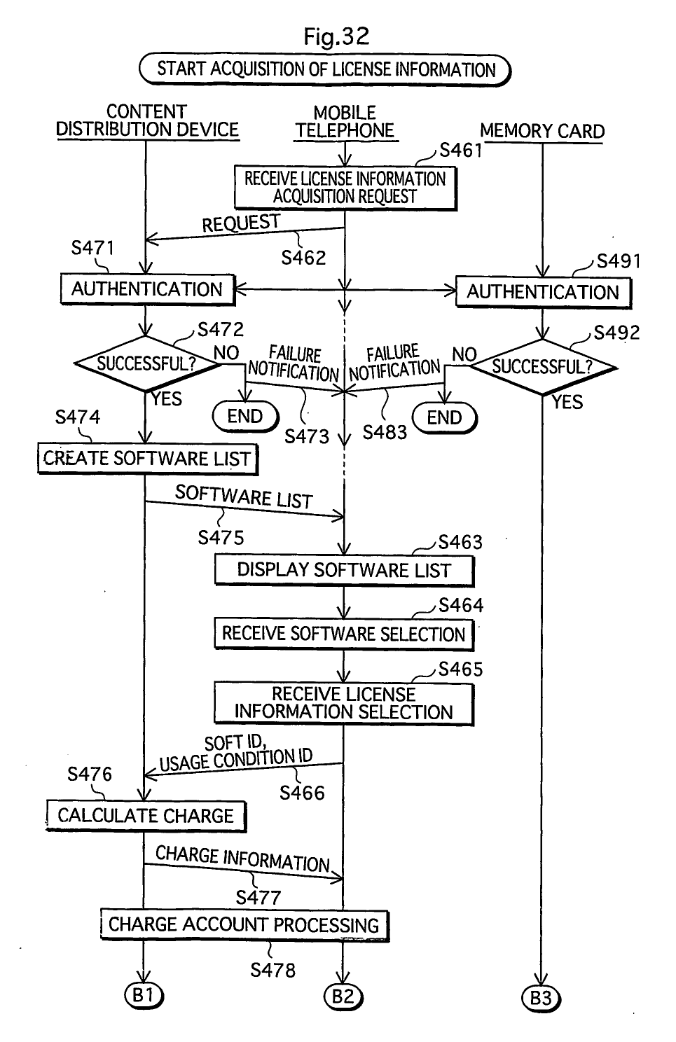

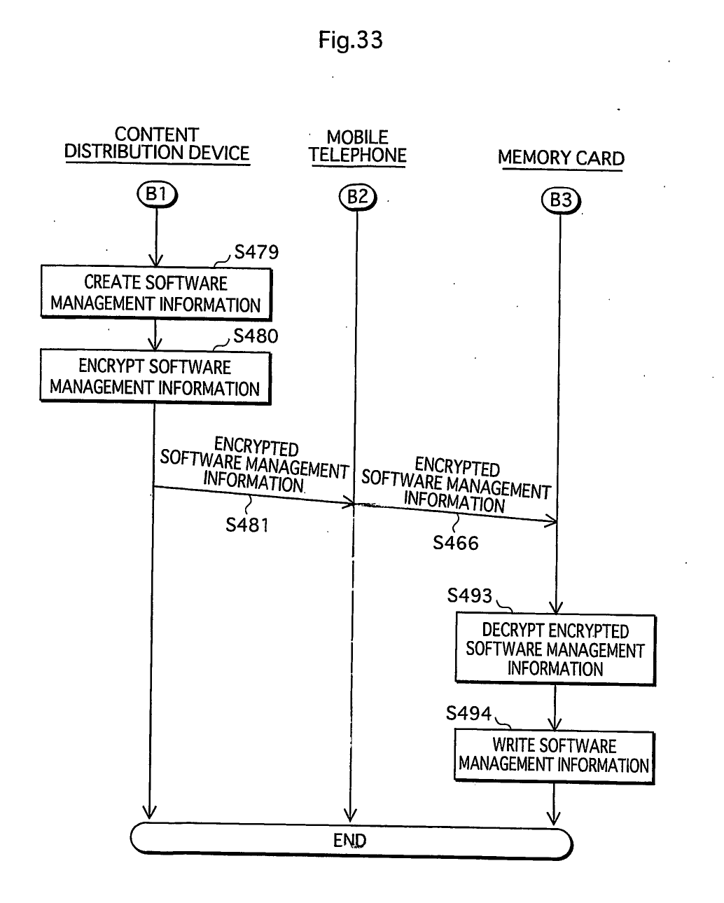

Operations for when SM information that includes license information is acquired from content-distribution device 400f by mobile telephone 500f and written to memory card 200f are described below using the flowchart shown in FIGS. 32-33.

Prior to acquisition of SM information being performed, memory card 200f is mounted on mobile telephone 500f by the user.

Mobile telephone 500f receives a request to acquire license information as the result of a user operation (step S461), and transmits the request to content-distribution device 400f via mobile network 21 (step S462).

Transmit/receive unit 402 in content-distribution device 400f receives the request from mobile telephone 500f via mobile network 21 (step S462), and authentication units 411 and 211 perform mutual device authentication via transmit/receive unit 402, mobile network 21, and mobile telephone 500f (steps S471, S491). If unsuccessful (steps S472, S492=NO), authentication units 411 and 211 output notifications to mobile telephone 500f showing that authentication was unsuccessful (steps S473, S483), and devices 400f and 200f terminate the processing to acquire license information.

If device authentication is successful (step S472=YES), authentication unit 411 outputs information showing that authentication was successful, and control unit 414 reads all of the SM information from the SM table stored in information storage unit 413, generates a software list using the read SM information (step S474), and transmits the generated list to mobile telephone 500f via mobile network 21 (step S475).

Mobile telephone 500f receives the software list from content-distribution device 400f via mobile network 21 (step S475), and displays the received list (step S463). Mobile telephone 500f then receives a software selection from the user (step S464), and further receives a license information selection from the user (step S465). Mobile telephone 500f transmits the soft ID identifying the selected software and the usage condition ID identifying the selected license information to transmit/receive unit 402 via mobile network 21 (step S466).

Control unit 414 receives the soft ID and the usage condition ID via mobile network 21 and transmit/receive unit 402 (step S466), calculates the charge based on the received soft ID and usage condition ID (step S476), and transmits payment information showing the calculated charge to mobile telephone 500f via transmit/receive unit 402 and mobile network 21 (step S477). Control unit 414 and mobile telephone 500f then perform charge account processing (step S478).

When the charge account processing has ended, control unit 414 generates SM information based on the received soft ID and usage condition ID, outputs the generated SM information to encryption unit 418, and instructs unit 418 to encrypt the SM information (step S479). Encryption unit 418 receives the SM information, performs encryption algorithm E3 on the received SM information to generate encrypted SM information (step S480), and transmits the encrypted SM information to memory card 200f via transmit/receive unit 402, mobile network 21, and mobile telephone 500f (steps S481, S466).

Decryption unit 212 in memory card 200f receives the encrypted SM information from content-distribution device 400f via mobile network 21, mobile telephone 500f, and I/O unit 201 (steps S481, S466), decrypts the encrypted SM information to generate SM information (step S493), and writes the SM information to SMI table 231 (step S494).

6.10 Software Installation, Uninstallation, Duplication, Deletion, Execution, and Playback by Information-Processing Device 300f

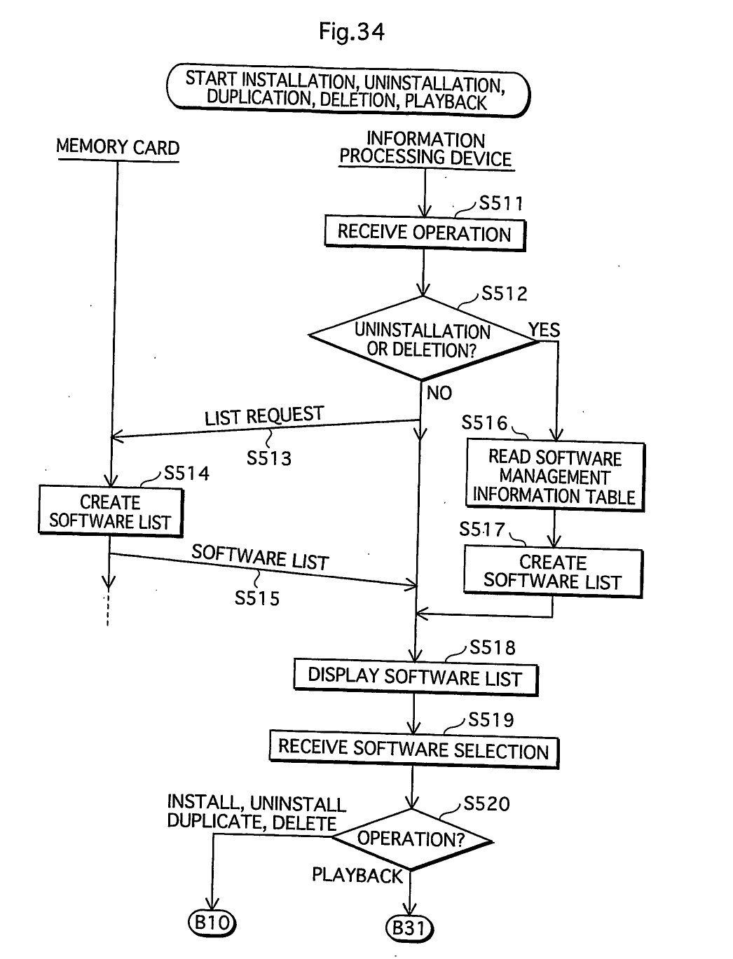

The following description relates to encrypted program installation/uninstallation, encrypted content duplication/deletion, and the decryption and playback (or execution) of an encrypted content (or program) stored on memory card 200f, using the flowcharts shown in FIG. 34-42.

Prior to the above operations being performed by information-processing device 300f, memory card 200f is mounted on device 300f by the user.

Input unit 323 receives input of an operation classification from the user, and outputs the classification to which the input relates to control unit 321 (step S511).

Control unit 321 receives the classification from input unit 323, and judges whether the received classification relates to uninstalling an encrypted program, deleting an encrypted an encrypted content, or another operation.

If judged that the received classification is either uninstalling an encrypted program or deleting an encrypted content (step S512=YES), control unit 321 reads all of the SH information from SHI table 331 stored in software storage unit 320 (step S516), generates a software list using the read SH information, and outputs the generated list to display unit 322 (step S517). Control then moves to step S518.

On the other hand, if judged that the received classification is another of the classifications (step S512=NO), control unit 321 outputs a list request for output of a software list to memory card 200f via I/O unit 301 (step S513).

I/O unit 201 in memory card 200f receives the list request from information-processing device 300f, and outputs the received request to judgment unit 214 (step S513).

Judgment unit 214, on receipt of the list request from I/O unit 201, reads SM information from SMI table 231 in second storage area 222 of information storage unit 220, generates a software list using the read SM information (step S514), and outputs the generated list to information-processing device 300f via I/O unit 201 (step S515).

Control unit 321 receives the software list from memory card 200f via I/O unit 301, and outputs the received list to display unit 322 (step S515).

Display unit 322 displayed the software list (step S518).

Input unit 323 receives a selection from the user of one of the pieces of software display information displayed as the software list, and outputs the soft ID included in the selected software display information to control unit 321 (step S519).

Control unit 321 then judges whether the classification received from input unit 323 is one of installation or uninstallation of an encrypted program, duplication or deletion of an encrypted content, or decryption/playback (or execution) of an encrypted content (or program) stored on memory card 200f.

If the received classification is judged to be one of installation/uninstallation of an encrypted program and duplication/deletion of an encrypted content (step S520), control moves to step S101f (FIG. 35).

If the received classification is judged to be decryption/playback (or execution) of an encrypted content (or program) stored on memory card 200f (step S520), control moves to step S101g (FIG. 40).

Operations for Installing/Uninstalling an Encrypted Program or Duplicating/Deleting an Encrypted Content

Operations for installing/uninstalling an encrypted program or duplicating/deleting an encrypted content are shown in steps S101f-S119f, S201f-S217f, and S151f-S155f of the flowcharts in FIGS. 35-39.

The steps in FIGS. 35-39 correspond to steps in the FIGS. 5-9 flowcharts shown by the same reference signs (numerals only). The following description focuses on the differences with the steps of the flowcharts shown in FIGS. 5-9.

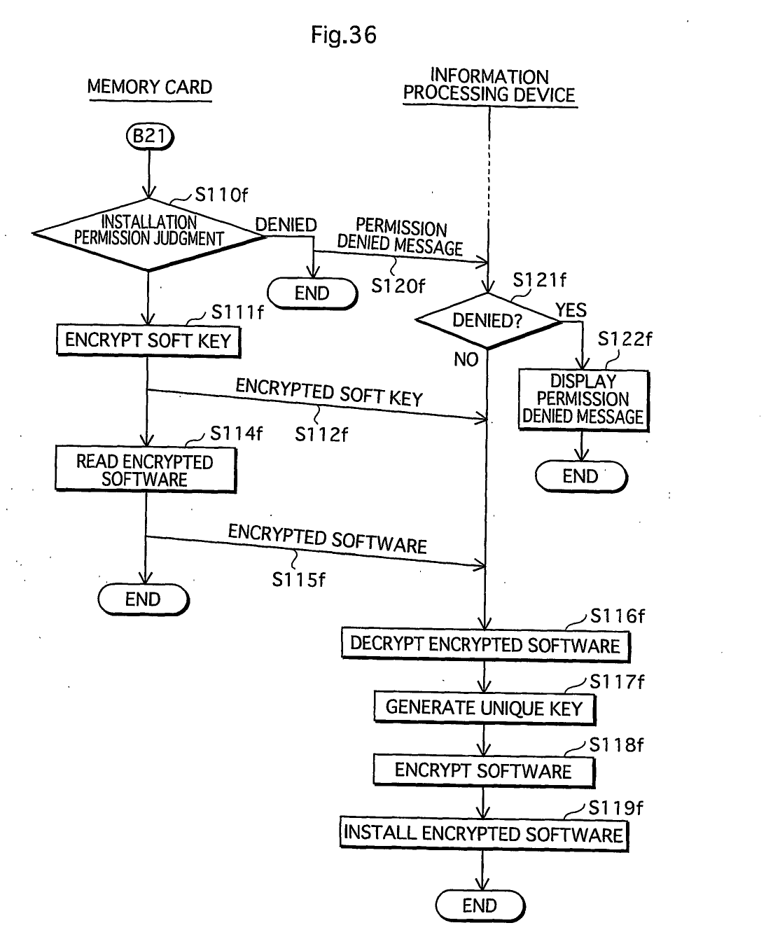

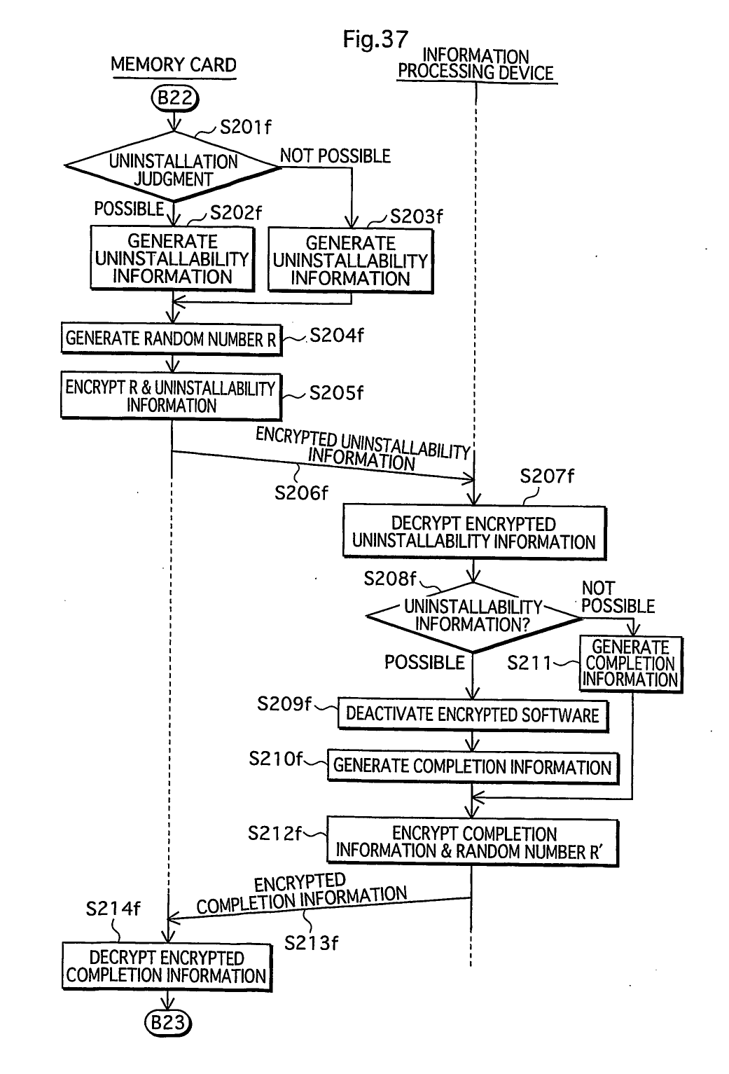

In step S109f (FIG. 35), judgment unit 214 judges whether the generated classification is one of program installation and content duplication, or program installation and content deletion. If the classification is judged to be program installation or content duplication, control is moved to step S110f (FIG. 36). On the other hand, if judged to be program installation or content deletion, control is moved to step S201f (FIG. 37).

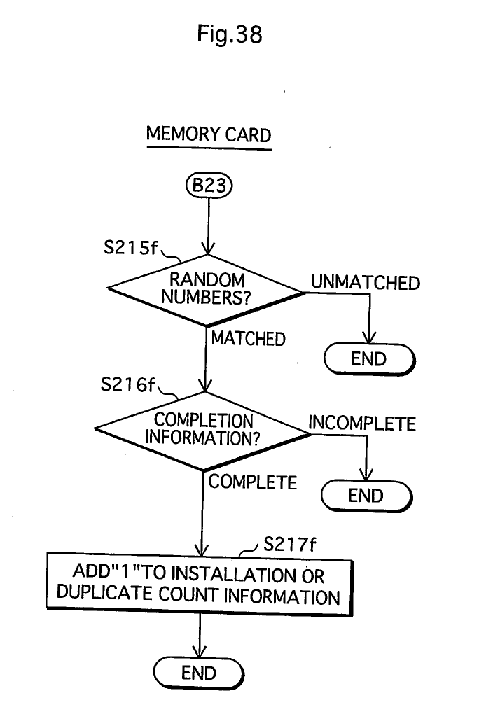

In step S217f (FIG. 38), judgment unit 214 adds “1” to the installation (or duplication) count information included in the SM information, and overwrites the SM information in SMI table 231 with the obtained value to update the installation (or duplication) count information.

Judgment unit 214 checks whether the device ID received from decryption unit 212 is included in the SM information received from second storage area 222 (step S151f), and if not included (step S151f=NO), unit 214 determines the request to be for program installation (or content duplication) to a new information-processing device, checks the installation (or duplication) count included in the SM information (step S153f), and judges installation (or duplication) to be permitted if the count is “1” or more. As this time, unit 214, in addition to adding (writing) the device ID received from decryption unit 212 to the SM information read from second storage area 222, writes updated SM information (i.e. installation count reduced by “1”) to second storage area 222 (step S155f). If the installation (or duplication) count is zero (step S153f), unit 214 judges installation (or duplication) to not be permitted. In step S151f, if the device ID is included in the received SM information (step S151f=YES), unit 214 determines the request to be for program reinstallation (or content reduplication) to an information-processing device to which the software has already been installed (or duplicated), and judges installation (or duplication) to be permitted.

Operations for Decrypting and Playing (or Executing) an Encrypted Content (or Program) Stored on Memory Card 200f

Authentication unit 311 in information-processing device 300f and authentication unit 211 in memory card 200f perform mutual device authentication (steps S101g, S102g in FIG. 40).

If authentication is successful (step S104g=YES), encryption unit 312 receives a session key from authentication unit 311, receives a soft ID from soft ID acquisition unit 318, encrypts the soft ID using the received session key to generate an encrypted soft ID (step S105g), and transmits the encrypted soft ID to memory card 200f via I/O unit 301 (step S106g).

If authentication is successful (step S103g=YES), decryption unit 212 receives a session key from authentication unit 211, decrypts the encrypted soft ID transmitted from information-processing device 300f using the received session key, and sends the generated soft ID to judgment unit 214 (step S107g).

If authentication is unsuccessful (step S103g, S104g=NO), devices 200f and 300f terminate any subsequent processing.

Judgment unit 214 then reads SM information corresponding to the generated soft ID from second storage area 222 (step S108g), judges whether to permit decryption/playback (or execution) of an encrypted content (or program) based on the read SM information (step S110g). Step S110g described in detail later.

If judged that playback (or execution) is not permitted (step S110g), judgment unit 214 transmits a message showing not permitted to information-processing device 300f (step S120g), and memory card 200f terminates the processing.

On receipt of a permission-denied message from memory card 200f (step S121g), control unit 321 controls display unit 322 to display the received message (step S122g), after which device 300f terminate the processing.

If judged that playback (or execution) is permitted (step S110g), judgment unit 214 sends the soft key included in the SM information to encryption unit 213, which encrypts the soft key using the session key received from authentication unit 211 to generate an encrypted soft key (step S111g), transmits the encrypted soft key to information-processing device 300f (step S112g). If control unit 321 does not receive a permission-denied message (step S121g=NO), encryption unit 313 decrypts the encrypted soft key received from memory card 200f using the session key received from authentication unit 311 (step S113g).

I/O unit 201 reads encrypted software from first storage area 221 (step S114g), and transmits the encrypted software to information-processing device 300f (step S115g). Decryption unit 314 decrypts the encrypted software using the decrypted soft key received from decryption unit 313, and outputs the decrypted software to software-execution unit 324 (step S116g). Unit 324 receives the software, and if a content, unit 324 plays the content, and if a computer program, unit 214 executes the program (step S117g).

Thus completes the decryption and playback (or execution) of encrypted contents (or programs).

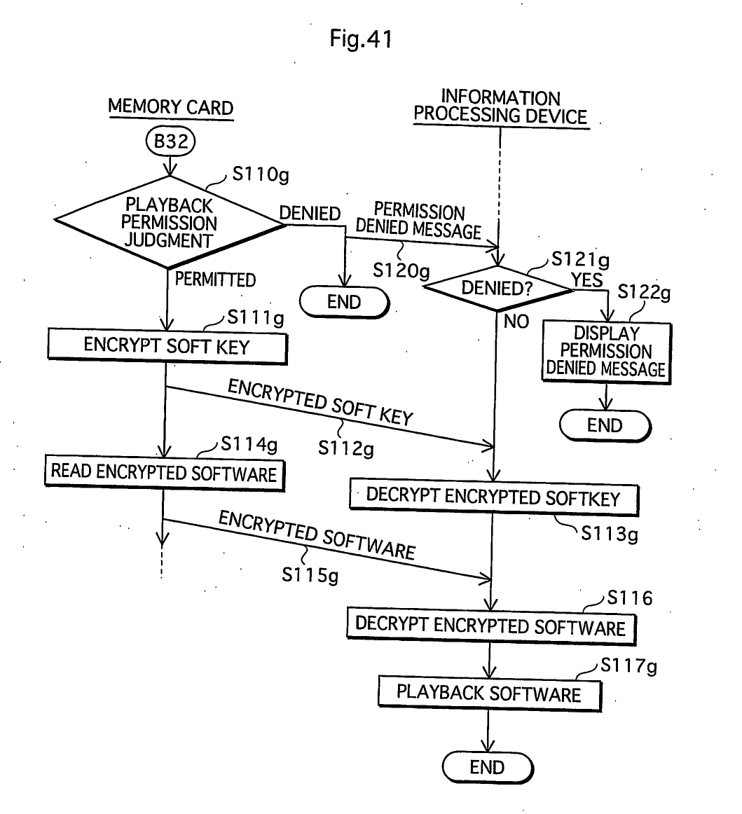

The following is a detailed description of operations performed by judgment unit 214 for judging whether to permit decryption and playback (or execution) of an encrypted content (or program). This description expands on step S110g in FIG. 41.

Judgment unit 214 judges whether the usage condition shows “playback count information” or “playback period”. If the usage condition shows “playback count information” (step S531), unit 214 judges whether the playback count is “1” or more, and if “1” or more (step S532), unit 214 reduces the playback count by “1” (step S533) and judges playback to be permitted. If the playback count is “0” (step S532), unit 214 judges playback to not be permitted.

If the usage condition shows “playback period” (step S531), unit 214 acquires the present date-time (step S534), judges whether the present date-time is within the playback period, and determines playback to be permitted if within the playback period (step S535). If outside the playback period (step S535), unit 214 determines playback to not be permitted.

6.11 Related Matters

Although in the above variations, software is described as being contents such as computer programs, movies, music and other kinds of digital copyrighted works, the present invention is not limited to this structure. The software may be electronic table data generated by spreadsheet software, data outputted by database software, and the like, or contents such as still-images, moving-images, novels and other types of text data. Conceptually, this software includes all kinds of computer data that is computer-readable and in usable-format.

In the above variations, mobile telephone 500f and information-processing device 300f may be constituted as a single device.

Also, mobile telephone 500f may be a personal digital assistant (PDA) having a wireless communication function.

Furthermore, the following structures are also possible.

(1) Although software-writing device 100f is described in variation 5 as being connected to content-distribution device 400f via Internet 20, and secretly transmitting SM information to content-distribution device 400f via Internet 20, the present invention is not limited to this structure.

For example, software-writing device 100f may securely store SM information on a recording medium. Then, an administrator of software-writing device 100f may send the recording medium storing the SM information to an administrator of content-distribution device 400f by postal mail. The content-distribution device 400f may then read the SM information from the recording medium sent by postal mail, and internally store the read SM information.

Furthermore, although software-writing device 100f and content-distribution device 400 are described as two separate devices, software-writing device 100f and content-distribution device 400 may be constituted as a single device.

(2) Although variation 5 describes encrypted software being written to memory card 200f inserted in software-writing device 100f, and memory card 200f storing the encrypted software being provided to a user through retailer 30, the present invention is not limited to this structure.

For example, similarly to variation 4, software-writing device 100f and information-processing device 300f may be connected via Internet 20, and memory card 200f may be inserted into information-processing device 300f. Consequently, encrypted software may be transmitted via Internet 20 to and stored by memory cared 200f.

(3) Furthermore, encrypted software may be transmitted in a similar manner to SM information. That is, encrypted software is first transmitted from software-writing device 100f to content-distribution device 400f, and then transmitted from content-distribution device 400f to memory card 200f via mobile network 21 and mobile phone 500f, so that encrypted software is written to memory card 200f.

(4) Furthermore, it is applicable that software-writing device 100f or content-distribution device 400f is connected to information-processing device 300f via a network such as the Internet. In this case, encrypted software is transmitted from software-writing device 100f or content-distribution device 400f to information-processing device 300f via the Internet, for example, and the received encrypted content is then written to software storage unit 320.

Here, license information corresponding to the encrypted software may be transmitted to memory card 200f and written therein through the operations described in variation 5. That is, corresponding SM information may be transmitted from content-distribution device 400f to memory card 200f via mobile network 21 and mobile phone 500f and recorded on memory card 200f. Decryption and execution (playback) of encrypted software stored in software storage unit 320 of information-processing device 300f may be performed through operations substantially similar to the above-described “Operations for Decrypting and Playing (or Executing) an Encrypted Content (or Program) Stored on Memory Card 200f”. The difference lies in whether encrypted software is read from memory card 200f or software storage unit 320.

(5) Although information-processing device 300f and mobile phone 500f are described in variation 5 as two separate devices, information-processing device 300f and mobile phone 500f may be constituted as a single device.

(6) In variation 5, the usage condition may be a combination of a plurality of conditions. For example, the usage condition may include both the playback count=“5” and the playback period=“1.1.2004˜31.1.2004 (from Jan. 1, 2004 until Jan. 31, 2004)”. In this case, judgment unit 214 judges playback to not be permitted once either the playback period has ended or the playback count is greater than or equal to “6”.

(7) Although variation 5 mentions examples of usage conditions, the usage conditions are not limited to the specific examples mentioned.

For example, a usage condition may include the number of days for which playback of software is permitted starting from the day on which the software is first played.

Furthermore, a usage condition may include a maximum cumulative number of hours permitted for playback of a content. In this case, playback of a content is permitted when the number of cumulative playback hours is smaller than or equal to the maximum cumulative number of hours, and not permitted when the number of cumulative playback hours exceeds the maximum cumulative number of hours.

7. Other Variations

The present invention, although described above based on the above embodiment, is of course not limited to this embodiment, the following cases also being included therein.

(1) The present invention may be a method of the above. Moreover, the method may be a computer program realized by a computer, or a digital signal formed from the program.

Furthermore, the present invention may be a floppy disk, a hard disk, a CD-ROM, an MO, a DVD, a DVD-ROM, a DVD-RAM, a BD (blu-ray disc), a semiconductor memory or similar computer-readable recording medium storing the program or the digital signal. Moreover, the present invention may be the program or digital signal recorded onto such a recording medium.

Also, the program or digital signal recorded onto such a recording medium may be transmitted via a network or the like, representative examples of which include a telecommunication circuit, a wireless or cable communication circuit, and the Internet.

Furthermore, the present invention may be a computer system that includes a microprocessor and a memory, the memory storing the program and the microprocessor operating in compliance with the program.

Furthermore, the present invention may be put into effect by another independent computer system as a result of transferring the program or the digital signal to the other computer system, either recorded on the recording medium or via a network or the like.

(2) The present invention may be any combination of the above embodiment and variations.

8. Effects

As described above, in a software-management system comprising a recording medium and an information-processing device, the recording medium includes: a normal storage unit having stored therein software that is computer data; a secure storage unit not directly accessible from outside, and having stored therein license information relating to a usage condition of the software; and a tamper-resistant module operable to judge, based on the license information, whether an operation, being one of installing software on the information-processing device and deactivating installed software, is permitted, and when judged in the affirmative, to output to the information-processing device an instruction showing that the operation is permitted, and to rewrite the license information in accordance with the operation. Furthermore, the information-processing device includes: a receiving unit operable to receive the instruction from the recording medium; and a control unit operable to perform, in accordance with the received instruction, one of (i) receiving software from the recording medium and installing the received software in the information-processing device, and (ii) deactivating installed software.

Since license information according to these structures is stored in a secure storage unit that cannot be directly accessed from outside, the license information cannot be easily tampered with. Also, since license information is not sent from the recording medium to a targeted information-processing device, there is no possibility of the license information being leaked and tampered with over a communication channel between the recording medium and the targeted device. Furthermore, since license information relating to the usage conditions of software is stored in the secure storage unit, there is no possibility of unauthorized alteration of the correspondence relationship between license information and software.

Here, the normal storage unit may store the software, being one of a computer program and digital data that have been encrypted using a soft key, the secure storage unit may store the license information, which includes the soft key, and the tamper-resistant module, when installation is judged to be permitted, may extract the soft key from the license information, and output the instruction with the extracted soft key included therein.

Since the tamper-resistant module according to this structure securely outputs a soft key used in encryption, there is no possibility of unauthorized alteration of the soft key.

Here, the secure storage unit may store the license information, which includes signature data relating to the software, and the tamper-resistant module, when installation is judged to be permitted, may extract the signature data from the license information, and output the instruction with the extracted signature data included therein.

Since the tamper-resistant module according to this structure outputs signature data relating to software, alteration of software can be detected.

Here, the secure storage unit may store the license information, which includes signature data relating to the software, and the tamper-resistant module, when installation is judged to be permitted, may extract the signature data from the license information, and output the extracted signature data instead of the instruction.

Since license information that includes software signature data is stored in the secure storage unit according to this structure, there is no possibility of unauthorized alteration of the correspondence relationship between license information and software.

Here, the secure storage unit may store the license information, which is generated by encrypting the usage condition using predetermined key information, and the tamper-resistant module may store the key information, decrypt the license information using the key information to generate the usage condition, and perform the judgment based on the generated usage condition.

Since the secure storage unit according to this structure stores license information generated by encrypting a usage condition using predetermined key information, and the tamper-resistant module decrypts the license information using the stored key information to generate the usage condition, it is only possible for a tamper-resistant module storing valid key information to use the license information.

Here, the secure storage unit may store a part rather than a whole of the license information, and the tamper-resistant module may store the remaining part of the license information, extract the part of the license information stored in the secure storage unit, generate the license information from the extracted part and the stored remaining part, and perform the judgment based on the generated license information.

Since the secure storage unit according to this structure stores part of the license information, the tamper-resistant module stores the remaining part of the license information, and the license information is generated from these stored parts, it is possible to further reduce the chances of license information being tampered with.

Here, the license information may be a permitted usage count of the software, and the tamper-resistant module may judge whether installation is permitted by judging whether the permitted usage count is greater than 0, judge that installation of the software is permitted when judged to be greater than 0, output the instruction, and write the permitted usage count to the secure storage unit after reducing the count by 1.

Since the license information according to this structure is a permitted usage count of the software, and the tamper-resistant module writes the permitted usage count to the secure storage unit after reducing the count by “1” if, at a time of installing the software, the permitted usage count is judged to be greater than “0”, it is possible to securely manage the permitted usage count of software.

Here, the license information may be a permitted usage count of the software, and the tamper-resistant module may output the instruction when judged that deactivation of the software is permitted, and write the permitted usage count to the secure storage unit after increasing the count by 1.

Since the license information according to this structure is a permitted usage count of the software, and, at a time of uninstalling the software, the tamper-resistant module writes the permitted usage count to the secure storage unit after increasing the count by “1”, it is possible to securely manage the permitted usage count of software.

As described above, in the recording medium, the secure storage unit may store the license information, which includes signature data relating to the software, the tamper-resistant module, when installation is judged to be permitted, may extract the signature data from the license information, and output the extracted signature data instead of the instruction, and in the information-processing device, the receiving unit may receive the signature data, and the control unit may verify a correctness of software received from the recording medium using the received the signature data, and if verification is successful, install the received software in the information-processing device.

Since verification of acquired software is conducted using signature data acquired from the recording medium according to this structure, and the acquired software is stored internally if verification is successful, it is possible to only acquire valid software for storing internally.

### INDUSTRIAL APPLICABILITY

The present invention can be used administratively as well as repetitively and continually in software industries that provide software such as contents, computer programs and the like comprising digitalized movies, music and other forms of copyrighted works. Furthermore, a software-writing device, an information-processing device, a server device, and a memory card of the present invention can be produced and retailed in manufacturing industries for electrical appliances and so forth.

1. A software-management system comprising a recording medium and an information-processing device, the recording medium including:
a normal storage unit having stored therein software that is computer data;
a secure storage unit not directly accessible from outside, and having stored therein license information relating to a usage condition of the software; and
a tamper-resistant module operable to judge, based on the license information, whether an operation, being one of installing software on the information-processing device and deactivating installed software, is permitted, and when judged in the affirmative, to output to the information-processing device an instruction showing that the operation is permitted, and to rewrite the license information in accordance with the operation, and
the information-processing device including:
a receiving unit operable to receive the instruction from the recording medium; and
a control unit operable to perform, in accordance with the received instruction, one of (i) receiving software from the recording medium and installing the received software in the information-processing device, and (ii) deactivating installed software.

2. The software-management system of claim 1, further comprising a software-writing device that includes:
an information-storage unit having stored therein software that is computer data, and license information relating to a usage condition of the software;
a reading unit operable to read the software and the license information from the information-storage unit; and
an output unit operable to output the read software and license information, wherein
the recording medium further includes:
a receiving unit operable to receive the software and the license information; and
a writing unit operable to write the received software to the normal storage unit and the received license information to the secure storage unit.

3. The software-management system of claim 2, wherein
the software-writing and information-processing devices are connected to each another via a network,
the output unit of the software-writing device outputs the software securely via the network,
the information-processing device further includes:
a receiving unit operable to receive the software securely via the network; and
an output unit operable to output the received software to the recording medium, and
the receiving unit of the recording medium receives the software from the information-processing device.

4. The software-management system of claim 2, further comprising a distribution device, wherein
the software-writing, information-processing, and distribution devices are connected to each another via a network,
the output unit of the software-writing device outputs the license information securely via the network,
the information-processing device further includes:
a receiving unit operable to receive the license information securely via the network; and
an output unit operable to output the received license information to the recording medium, and
the receiving unit of the recording medium receives the license information from the information-processing device.

5. A recording medium, comprising:
a normal storage unit having stored therein software that is computer data;
a secure storage unit not directly accessible from outside, and having stored therein license information relating to a usage condition of the software; and
a tamper-resistant module operable to judge, based on the license information, whether an operation, being one of installing software on an information-processing device and deactivating installed software, is permitted, and when judged in the affirmative, to output to the information-processing device an instruction showing that the operation is permitted, and to rewrite the license information in accordance with the operation.

6. The recording medium of claim 5, wherein
the normal storage unit stores the software, being one of a computer program and digital data,
the secure storage unit stores the license information, which relates to a usage condition of one of the computer program and the digital data, and
the tamper-resistant module judges whether the operation, being one of (i) installing or uninstalling the computer program with respect to the information-processing device and (ii) duplicating or deleting the digital data, is permitted.

7. The recording medium of claim 5, wherein
the normal storage unit stores the software, being one of a computer program and digital data that have been encrypted using a soft key,
the secure storage unit stores the license information, which includes the soft key, and
the tamper-resistant module, when installation is judged to be permitted, extracts the soft key from the license information, and outputs the instruction with the extracted soft key included therein.

8. The recording medium of claim 5, wherein
the secure storage unit stores the license information, which includes signature data relating to the software, and
the tamper-resistant module, when installation is judged to be permitted, extracts the signature data from the license information, and outputs the instruction with the extracted signature data included therein.

9. The recording medium of claim 5, wherein
the secure storage unit stores the license information, which includes signature data relating to the software, and
the tamper-resistant module, when installation is judged to be permitted, extracts the signature data from the license information, and outputs the extracted signature data instead of the instruction.

10. The recording medium of claim 5, wherein
the secure storage unit stores the license information, which is generated by encrypting the usage condition using predetermined key information, and
the tamper-resistant module stores the key information, decrypts the license information using the key information to generate the usage condition, and performs the judgment based on the generated usage condition.

11. The recording medium of claim 5, wherein
the secure storage unit stores a part rather than a whole of the license information, and
the tamper-resistant module stores the remaining part of the license information, extracts the part of the license information stored in the secure storage unit, generates the license information from the extracted part and the stored remaining part, and performs the judgment based on the generated license information.

12. The recording medium of claims 5, wherein
the license information is a permitted usage count of the software, and
the tamper-resistant module judges whether installation is permitted by judging whether the permitted usage count is greater than 0, judges that installation of the software is permitted when judged to be greater than 0, outputs the instruction, and writes the permitted usage count to the secure storage unit after reducing the count by 1.

13. The recording medium of claim 5, wherein
the license information is a permitted usage count of the software, and
the tamper-resistant module outputs the instruction when judged that deactivation of the software is permitted, and writes the permitted usage count to the secure storage unit after increasing the count by 1.

14. The recording medium of claim 5, wherein
the license information is a permitted usage period of the software, and
the tamper-resistant module judges whether installation is permitted by judging whether a current date-time is within the permitted usage period, judges that installation of the software is permitted when judged to be within the permitted usage period, and outputs the instruction.

15. An information-processing device that performs at least one of installing and deactivating software, comprising:
a receiving unit operable to receive an instruction from a recording medium; and
a control unit operable to perform, in accordance with the received instruction, one of (i) receiving software from the recording medium and installing the received software in the information-processing device, and (ii) deactivating installed software, wherein
the recording medium includes:
a normal storage unit having stored therein software that is computer data;
a secure storage unit not directly accessible from outside, and having stored therein license information relating to a usage condition of the software; and
a tamper-resistant module operable to judge, based on the license information, whether an operation, being one of installing software on the information-processing device and deactivating installed software, is permitted, and when judged in the affirmative, to output to the information-processing device an instruction showing that the operation is permitted, and to rewrite the license information in accordance with the operation.

16. The information-processing device of claim 15, wherein
the secure storage unit of the recording medium stores the license information, which includes signature data relating to the software,
the tamper-resistant module of the recording medium, when installation is judged to be permitted, extracts the signature data from the license information, and outputs the instruction with the extracted signature data included therein,
the receiving unit receives the instruction with the signature data included therein, and
the control unit performs one of (i) verifying a correctness of software received from the recording medium using the received software and the signature data included in the received instruction and (ii) verifying a correctness of software installed in the information-processing device using the installed software and the signature data included in the received instruction, and if verification is successful, performs the operation.

17. The information-processing device of claim 15, wherein
the secure storage unit of the recording medium stores the license information, which includes signature data relating to the software,
the tamper-resistant module of the recording medium, when installation is judged to be permitted, extracts the signature data from the license information, and outputs the extracted signature data instead of the instruction,
the receiving unit receives the signature data, and
the control unit verifies a correctness of software received from the recording medium using the received the signature data, and if verification is successful, installs the received software in the information-processing device.

18. A control method used by a recording medium that includes a normal storage unit having stored therein software that is computer data, a secure storage unit not directly accessible from outside and having stored therein license information relating to a usage condition of the software, and a tamper-resistant module, comprising the steps of:
judging, based on the license information, whether an operation, being one of installing software on an information-processing device and deactivating installed software, is permitted;
outputting to the information-processing device when judged in the affirmative, an instruction showing the operation to be permitted; and
rewriting the license information in accordance with the operation.

19. A control computer program used by a recording medium that includes a normal storage unit having stored therein software that is computer data, a secure storage unit not directly accessible from outside and having stored therein license information relating to a usage condition of the software, and a tamper-resistant module, comprising the steps of:
judging, based on the license information stored in the secure storage unit, whether an operation, being one of installing software on an information processing device and deactivating installed software, is permitted;
outputting to the information-processing device when judged in the affirmative, an instruction showing the operation to be permitted; and
rewriting the license information in accordance with the operation.

20. The computer problem of claim 19 is stored on a computer-readable recording medium.

21. A software-management method used by an information-processing device that performs at least one of installing and deactivating software, comprising the steps of:
receiving an instruction from a recording medium; and
performing, in accordance with the received instruction, one of (i) receiving software from the recording medium and installing the received software in the information-processing device, and (ii) deactivating installed software, wherein
the recording medium includes:
a normal storage unit having stored therein software that is computer data;
a secure storage unit not directly accessible from outside, and having stored therein license information relating to a usage condition of the software; and
a tamper-resistant module operable to judge, based on the license information, whether an operation, being one of installing software on the information-processing device and deactivating installed software, is permitted, and when judged in the affirmative, to output to the information-processing device an instruction showing that the operation is permitted, and to rewrite the license information in accordance with the operation.

22. A software-management computer program used by an information processing device that performs at least one of installing and deactivating software, comprising the steps of:
receiving an instruction from a recording medium; and
performing, in accordance with the received instruction, one of (i) receiving software from the recording medium and installing the received software in the information-processing device, and (ii) deactivating installed software, wherein
the recording medium includes:
a normal storage unit having stored therein software that is computer data;
a secure storage unit not directly accessible from outside, and having stored therein license information relating to a usage condition of the software; and
a tamper-resistant module operable to judge, based on the license information, whether an operation, being one of installing software on the information-processing device and deactivating installed software, is permitted, and when judged in the affirmative, to output to the information-processing device an instruction showing that the operation is permitted, and to rewrite the license information in accordance with the operation.

23. The computer program of claim 22 is stored on a computer-readable recording medium.
